(19) United States
(12) Patent Application Publication
(10) Pub. No.: US 2026/0312738 A1
(43) Pub. Date: Oct. 8, 2026

(54) HYBRID AUTOMATIC REPEAT REQUEST COMMUNICATION

(71) Applicant: QUALCOMM Incorporated, San Diego, CA (US)

(72) Inventors: Abdelrahman Mohamed IBRAHIM, San Diego, CA (US); Muhammad Sayed Khairy ABDELGHAFFAR, San Jose, CA (US); Mohammed JABI, San Diego, CA (US)

(21) Appl. No.: 19/542,228

(22) Filed: Feb. 17, 2026

Related U.S. Application Data
(60) Provisional application No. 63/782,916, filed on Apr. 3, 2025.

(51) Int. Cl. H04L 1/1867; H04L 5/00; H04L 5/14

(52) U.S. Cl. CPC H04L 1/1896; H04L 5/0044; H04L 5/1453

(57) ABSTRACT

Various aspects of the present disclosure generally relate to wireless communication. In some aspects, a user equipment (UE) may receive configuration information associated with a single downlink control information (DCI) communication scheduling multiple physical downlink shared channel (PDSCH) receptions, wherein the configuration information is associated with a first sub-band full-duplex (SBFD) configuration and a second SBFD configuration. The UE may receive DCI that schedules the multiple PDSCH receptions. The UE may transmit hybrid automatic repeat request (HARQ) information based at least in part on whether the UE is provided with the time domain bundling information or the HARQ bundling group information and based at least in part on whether the UE is provided with the spatial bundling information. Numerous other aspects are described.

### CROSS-REFERENCE TO RELATED APPLICATION

This Patent Application claims priority to U.S. Provisional Patent Application No. 63/782,916, filed on Apr. 3, 2025, entitled “HYBRID AUTOMATIC REPEAT REQUEST COMMUNICATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with hybrid automatic repeat request communication.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

In some aspects, a method of wireless communication performed by a user equipment (UE) includes receiving configuration information associated with a single downlink control information (DCI) communication scheduling multiple physical downlink shared channel (PDSCH) receptions, wherein the configuration information is associated with a first sub-band full-duplex (SBFD) configuration and a second SBFD configuration, the first SBFD configuration indicating that communications by the UE are restricted to only one of SBFD symbols or non-SBFD symbols across a plurality of slots and the second SBFD configuration indicating that communications by the UE can be performed in both the SBFD symbols and the non-SBFD symbols across the plurality of slots, wherein the configuration information further indicates for the UE to transmit hybrid automatic repeat request (HARQ) information associated with a first HARQ type or a second HARQ type based at least in part on whether the UE is provided with at least one of time domain bundling information or HARQ bundling group information and based at least in part on whether the UE is provided with spatial bundling information; receiving DCI that schedules the multiple PDSCH receptions; and transmitting HARQ information based at least in part on whether the UE is provided with the time domain bundling information or the HARQ bundling group information and based at least in part on whether the UE is provided with the spatial bundling information.

In some aspects, a method of wireless communication performed by a network node includes transmitting configuration information associated with a single DCI communication scheduling multiple PDSCH receptions, wherein the configuration information is associated with a first SBFD configuration and a second SBFD configuration, the first SBFD configuration indicating that communications by a UE are restricted to only one of SBFD symbols or non-SBFD symbols across a plurality of slots and the second SBFD configuration indicating that communications by the UE can be performed in both the SBFD symbols and the non-SBFD symbols across the plurality of slots, wherein the configuration information further indicates for the UE to transmit HARQ information associated with a first HARQ type or a second HARQ type based at least in part on whether the UE is provided with at least one of time domain bundling information or HARQ bundling group information and based at least in part on whether the UE is provided with spatial bundling information; transmitting DCI that schedules the multiple PDSCH receptions; and receiving HARQ information based at least in part on whether the UE is provided with the time domain bundling information or the HARQ bundling group information and based at least in part on whether the UE is provided with the spatial bundling information.

In some aspects, an apparatus for wireless communication at a UE includes one or more memories; and one or more processors, coupled to the one or more memories, which, individually or in any combination, are operable to cause the UE to: receive configuration information associated with a single DCI communication scheduling multiple PDSCH receptions, wherein the configuration information is associated with a first SBFD configuration and a second SBFD configuration, the first SBFD configuration indicating that communications by the UE are restricted to only one of SBFD symbols or non-SBFD symbols across a plurality of slots and the second SBFD configuration indicating that communications by the UE can be performed in both the SBFD symbols and the non-SBFD symbols across the plurality of slots, wherein the configuration information further indicates for the UE to transmit HARQ information associated with a first HARQ type or a second HARQ type based at least in part on whether the UE is provided with at least one of time domain bundling information or HARQ bundling group information and based at least in part on whether the UE is provided with spatial bundling information; receive DCI that schedules the multiple PDSCH receptions; and transmit HARQ information based at least in part on whether the UE is provided with the time domain bundling information or the HARQ bundling group information and based at least in part on whether the UE is provided with the spatial bundling information.

In some aspects, an apparatus for wireless communication at a network node includes one or more memories; and one or more processors, coupled to the one or more memories, which, individually or in any combination, are operable to cause the network node to: transmit configuration information associated with a single DCI communication scheduling multiple PDSCH receptions, wherein the configuration information is associated with a first SBFD configuration and a second SBFD configuration, the first SBFD configuration indicating that communications by a UE are restricted to only one of SBFD symbols or non-SBFD symbols across a plurality of slots and the second SBFD configuration indicating that communications by the UE can be performed in both the SBFD symbols and the non-SBFD symbols across the plurality of slots, wherein the configuration information further indicates for the UE to transmit HARQ information associated with a first HARQ type or a second HARQ type based at least in part on whether the UE is provided with at least one of time domain bundling information or HARQ bundling group information and based at least in part on whether the UE is provided with spatial bundling information; transmit DCI that schedules the multiple PDSCH receptions; and receive HARQ information based at least in part on whether the UE is provided with the time domain bundling information or the HARQ bundling group information and based at least in part on whether the UE is provided with the spatial bundling information.

In some aspects, a non-transitory computer-readable medium storing a set of instructions for wireless communication includes one or more instructions that, when executed by one or more processors of a UE, cause the UE to: receive configuration information associated with a single DCI communication scheduling multiple PDSCH receptions, wherein the configuration information is associated with a first SBFD configuration and a second SBFD configuration, the first SBFD configuration indicating that communications by the UE are restricted to only one of SBFD symbols or non-SBFD symbols across a plurality of slots and the second SBFD configuration indicating that communications by the UE can be performed in both the SBFD symbols and the non-SBFD symbols across the plurality of slots, wherein the configuration information further indicates for the UE to transmit HARQ information associated with a first HARQ type or a second HARQ type based at least in part on whether the UE is provided with at least one of time domain bundling information or HARQ bundling group information and based at least in part on whether the UE is provided with spatial bundling information; receive DCI that schedules the multiple PDSCH receptions; and transmit HARQ information based at least in part on whether the UE is provided with the time domain bundling information or the HARQ bundling group information and based at least in part on whether the UE is provided with the spatial bundling information.

In some aspects, a non-transitory computer-readable medium storing a set of instructions for wireless communication includes one or more instructions that, when executed by one or more processors of a network node, cause the network node to: transmit configuration information associated with a single DCI communication scheduling multiple PDSCH receptions, wherein the configuration information is associated with a first SBFD configuration and a second SBFD configuration, the first SBFD configuration indicating that communications by a UE are restricted to only one of SBFD symbols or non-SBFD symbols across a plurality of slots and the second SBFD configuration indicating that communications by the UE can be performed in both the SBFD symbols and the non-SBFD symbols across the plurality of slots, wherein the configuration information further indicates for the UE to transmit HARQ information associated with a first HARQ type or a second HARQ type based at least in part on whether the UE is provided with at least one of time domain bundling information or HARQ bundling group information and based at least in part on whether the UE is provided with spatial bundling information; transmit DCI that schedules the multiple PDSCH receptions; and receive HARQ information based at least in part on whether the UE is provided with the time domain bundling information or the HARQ bundling group information and based at least in part on whether the UE is provided with the spatial bundling information.

In some aspects, an apparatus for wireless communication includes means for receiving configuration information associated with a single DCI communication scheduling multiple PDSCH receptions, wherein the configuration information is associated with a first SBFD configuration and a second SBFD configuration, the first SBFD configuration indicating that communications by the apparatus are restricted to only one of SBFD symbols or non-SBFD symbols across a plurality of slots and the second SBFD configuration indicating that communications by the apparatus can be performed in both the SBFD symbols and the non-SBFD symbols across the plurality of slots, wherein the configuration information further indicates for the apparatus to transmit HARQ information associated with a first HARQ type or a second HARQ type based at least in part on whether the apparatus is provided with at least one of time domain bundling information or HARQ bundling group information and based at least in part on whether the apparatus is provided with spatial bundling information; means for receiving DCI that schedules the multiple PDSCH receptions; and means for transmitting HARQ information based at least in part on whether the apparatus is provided with the time domain bundling information or the HARQ bundling group information and based at least in part on whether the apparatus is provided with the spatial bundling information.

In some aspects, an apparatus for wireless communication includes means for transmitting configuration information associated with a single DCI communication scheduling multiple PDSCH receptions, wherein the configuration information is associated with a first SBFD configuration and a second SBFD configuration, the first SBFD configuration indicating that communications by a UE are restricted to only one of SBFD symbols or non-SBFD symbols across a plurality of slots and the second SBFD configuration indicating that communications by the UE can be performed in both the SBFD symbols and the non-SBFD symbols across the plurality of slots, wherein the configuration information further indicates for the UE to transmit HARQ information associated with a first HARQ type or a second HARQ type based at least in part on whether the UE is provided with at least one of time domain bundling information or HARQ bundling group information and based at least in part on whether the UE is provided with spatial bundling information; means for transmitting DCI that schedules the multiple PDSCH receptions; and means for receiving HARQ information based at least in part on whether the UE is provided with the time domain bundling information or the HARQ bundling group information and based at least in part on whether the UE is provided with the spatial bundling information.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating examples of full-duplex communication in a wireless network.

FIGS. 3A-3C are diagrams illustrating examples of full duplex communication.

FIG. 4 is a diagram illustrating an example of sub-band full duplex activation.

FIG. 5 is a diagram illustrating an example of hybrid automatic repeat request communications.

FIG. 6 is a diagram illustrating an example of hybrid automatic repeat request communications.

FIG. 7 is a diagram illustrating an example process performed, for example, at a user equipment or an apparatus of a user equipment.

FIG. 8 is a diagram illustrating an example process performed, for example, at a network node or an apparatus of a network node.

FIG. 9 is a diagram of an example apparatus for wireless communication.

FIG. 10 is a diagram of an example apparatus for wireless communication.

### DETAILED DESCRIPTION

“Full duplex” refers to a communication mode in which data can be transmitted and received simultaneously over the same communication channel. This is in contrast to half-duplex systems, where communication can only occur in one direction at a time. In wireless communications, full duplex allows both the transmitter and receiver to operate concurrently without interference, effectively doubling the potential throughput of the communication link. Sub-band full duplex (SBFD) is a type of full-duplex communication where the frequency spectrum is divided into multiple sub-bands. In SBFD, instead of using the entire bandwidth for simultaneous transmission and reception, the spectrum is divided into smaller frequency bands, with each sub-band handling either transmission or reception. This approach can reduce interference between the transmitted and received signals, allowing for more efficient spectrum use.

Hybrid automatic repeat request (HARQ) is an error correction protocol used in wireless communications to improve the reliability of data transmission. HARQ can combine both forward error correction (FEC) and automatic repeat request (ARQ) mechanisms and can be used to send redundant information along with the original message such that, if any part of the transmission is received incorrectly, the receiver can use the redundant data to correct the errors. However, if the errors are too significant, the receiver may request a retransmission of the data. In some cases, HARQ can be classified as Type I HARQ and Type II HARQ. HARQ codebooks may generally be categorized into Type 1 HARQ codebooks or Type 2 HARQ codebooks. The Type 1 HARQ codebook (which may be a semi-static HARQ codebook) may provide feedback for all potential physical downlink shared channel (PDSCH) transmissions, regardless of whether the transmissions actually occurred. The Type 1 HARQ codebook may be configured based at least in part on one or more combinations of timing offsets between a PDSCH communication and a corresponding HARQ feedback and one or more time domain resource allocation table entries that define the location and duration of PDSCH transmissions within a slot. This approach may improve robustness by covering all possible transmission opportunities. In contrast, Type 2 dynamic HARQ codebooks may offer a more compact representation by including feedback only for those PDSCH transmissions that were actually carried out. While Type 2 may be more efficient in terms of signaling overhead, Type 1 may provide greater reliability by accounting for a broader set of possible transmission scenarios.

A user equipment (UE) configured to perform uplink transmissions and downlink receptions across SBFD symbols and non-SBFD symbols in different slots (e.g., where each transmission or reception within the slot has either all SBFD symbols or all non-SBFD symbols) may be provided with multiple SBFD configurations. In a first SBFD configuration, the transmissions and receptions by the UE are restricted to the SBFD symbols only or the non-SBFD symbols only. In a second SBFD configuration, the transmissions and receptions may be performed in the SBFD symbols and in the non-SBFD symbols. In some cases, the SBFD-configured UE may be configured with the second SBFD configuration on a per-uplink bandwidth part (BWP) basis or on a per-downlink BWP basis. The configuration for the downlink BWP may apply to PDSCH receptions within the downlink BWP, while the configuration for the uplink BWP may apply to physical uplink control channel (PUCCH) and physical uplink shared channel (PUSCH) transmissions within the uplink BWP. In some cases, only the first SBFD configuration may be applicable for sounding reference signal (SRS) transmissions.

In some cases, certain symbol types (e.g., uplink symbols or downlink symbols) may be excluded from transmission in accordance with one or more exclusion rules. However, these exclusion rules may not be in accordance with whether the first SBFD configuration of the second SBFD configuration is being used by the UE for uplink and downlink transmissions across multiple slots. When a single DCI message schedules multiple PDSCH receptions by the UE, the UE may be unable to properly determine how to transmit HARQ feedback. For example, the ability of the UE to generate HARQ feedback may depend on whether certain information is provided to the UE, such as time domain bundling information (e.g., timeDomainHARQ-BundlingTypeI), HARQ bundling group information (e.g., nrofHARQ-BundlingGroups), or spatial bundling information (e.g., harq-ACK-SpatialBundlingPUCCH). In some cases, the inability of the UE to properly transmit HARQ feedback may result in the UE transmitting incorrect HARQ feedback, which may lead to repeated retransmissions and increased network latency. In some cases, the inability of the UE to properly transmit HARQ feedback may result in data loss and throughput reduction. For example, failure by the UE to provide accurate HARQ acknowledgments may cause packet losses, reducing the overall system throughput. In some cases, the inability of the UE to properly transmit HARQ feedback may result in increased control signaling overhead. For example, to compensate for HARQ uncertainty, the network may need to transmit additional control information, adding overhead and consuming valuable resources. In some cases, the inability of the UE to properly transmit HARQ feedback may result in improper resource allocation. For example, ambiguity regarding SBFD and non-SBFD slot types may lead to inefficient resource scheduling, potentially underutilizing available bandwidth. In some cases, the inability of the UE to properly transmit HARQ feedback may result in reduced or inconsistent quality of service (QoS). For example, as the UE struggles to determine the correct HARQ configuration, some data streams may experience increased delays or reduced reliability.

Various aspects generally relate to wireless communications. Some aspects more specifically relate to HARQ communication. In some aspects, a network node may transmit, and a UE may receive, configuration information associated with a single DCI communication scheduling PDSCH reception. The configuration information may indicate at least one of a first SBFD configuration or a second SBFD configuration. The first SBFD configuration may indicate that communications by the UE are restricted to only one of SBFD symbols or non-SBFD symbols across a plurality of slots. In contrast, the second SBFD configuration may indicate that communications by the UE can be performed in both the SBFD symbols and the non-SBFD symbols across the plurality of slots. Further, the configuration information may indicate for the UE to transmit HARQ information associated with a first HARQ type (e.g., Type I HARQ) or a second HARQ type (e.g., Type II HARQ) based at least in part on whether the UE is provided with at least one of time domain bundling information or HARQ bundling group information and based at least in part on whether the UE is provided with spatial bundling information. The network node may transmit, and the UE may receive, DCI that schedules the multiple PDSCH receptions by the UE. The UE may generate HARQ information based at least in part on whether the UE is provided with the time domain bundling information or the HARQ bundling group information and based at least in part on whether the UE is provided with the spatial bundling information, and may transmit the HARQ information to the network node.

Particular aspects of the subject matter described in this disclosure can be implemented to realize one or more of the following potential advantages. In some examples, the described techniques can be used to improve HARQ communications. In some examples, by enabling the UE to transmit HARQ information based at least in part on the configuration information and the single DCI scheduling the multiple PDSCH receptions, the described techniques can be used to reduce a quantity of retransmissions and to reduce network latency. In some examples, by enabling the UE to transmit HARQ information based at least in part on the configuration information and the single DCI scheduling the multiple PDSCH receptions, the described techniques can be used to reduce data loss and increase throughput in the network. In some examples, by enabling the UE to transmit HARQ information based at least in part on the configuration information and the single DCI scheduling the multiple PDSCH receptions, the described techniques can be used to reduce control signaling overhead. In some examples, by enabling the UE to transmit HARQ information based at least in part on the configuration information and the single DCI scheduling the multiple PDSCH receptions, the described techniques can be used to improve resource allocation. In some examples, by enabling the UE to transmit HARQ information based at least in part on the configuration information and the single DCI scheduling the multiple PDSCH receptions, the described techniques can be used to increase quality of service. These example advantages, among others, are described in more detail below.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

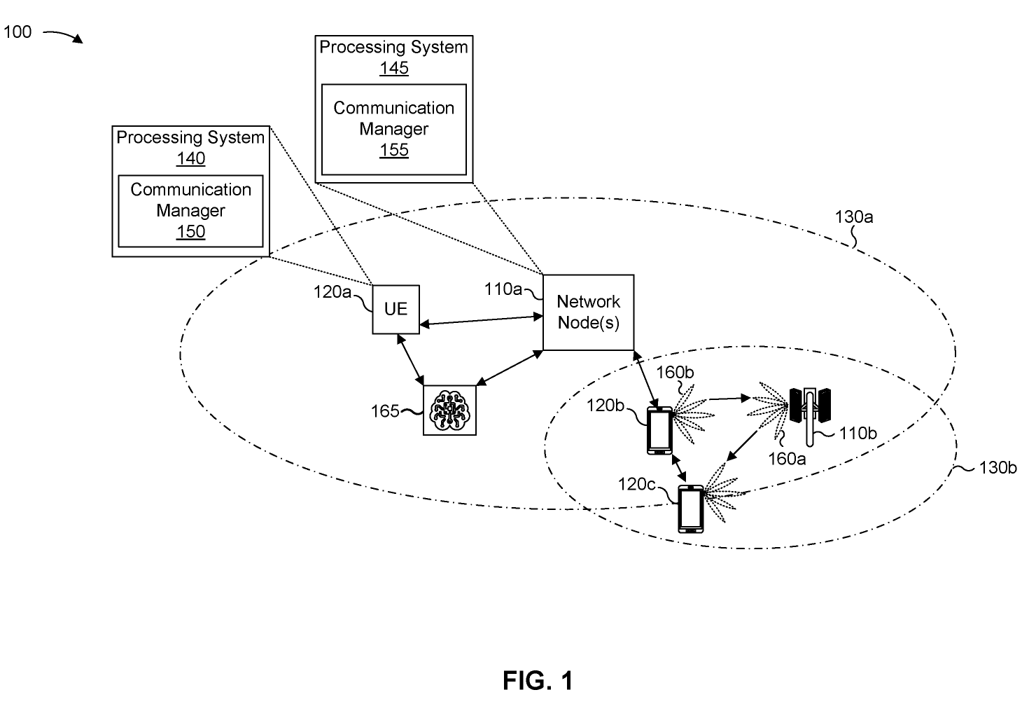

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 operating in a half-duplex mode may perform only one of transmission or reception during particular time resources, such as during particular slots, symbols, or other time periods. In various examples, some of the network nodes 110 and the UEs 120 of the wireless communication network 100 may be configured for full-duplex operation in addition to half-duplex operation. In full-duplex operation, a network node 110 or a UE 120 operating in a full-duplex (for example, SBFD) mode can transmit and receive communications concurrently (for example, in the same time resources). For example, as shown in FIG. 1, the network node 110b may operate in the full-duplex mode. The network node 110b may concurrently receive uplink communications from the UE 120b and transmit downlink communications to the UE 120c. By operating in a full-duplex mode, network nodes 110 or UEs 120 may generally increase the capacity of the network and the radio access link. In some examples, full-duplex operation may involve frequency division duplexing (FDD), in which downlink transmissions of the network node 110b are performed in a first frequency band or on a first component carrier and transmissions of the UE 120b are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an uplink transmission to a first network node 110 and receive a downlink transmission from a second network node 110 in the same time resources. In some other examples, full-duplex operation may be enabled for a network node 110 but not for a UE 120. For example, the network node 110b may simultaneously transmit a downlink transmission to a first UE 120 (for example, the UE 120c) and receive an uplink transmission from a second UE 120 (for example, the UE 120b) in the same time resources. In some other examples, full-duplex operation may be enabled for both a network node 110 and a UE 120.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110aor the UE 120a(for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may receive configuration information associated with a single DCI communication scheduling multiple PDSCH receptions, wherein the configuration information is associated with a first SBFD configuration and a second SBFD configuration, the first SBFD configuration indicating that communications by the UE are restricted to only one of SBFD symbols or non-SBFD symbols across a plurality of slots and the second SBFD configuration indicating that communications by the UE can be performed in both the SBFD symbols and the non-SBFD symbols across the plurality of slots, wherein the configuration information further indicates for the UE to transmit HARQ information associated with a first HARQ type or a second HARQ type based at least in part on whether the UE is provided with at least one of time domain bundling information or HARQ bundling group information and based at least in part on whether the UE is provided with spatial bundling information; receive DCI that schedules the multiple PDSCH receptions; and transmit HARQ information based at least in part on whether the UE is provided with the time domain bundling information or the HARQ bundling group information and based at least in part on whether the UE is provided with the spatial bundling information. Additionally, or alternatively, the communication manager 150 may perform one or more other operations described herein.

In some aspects, the network node 110 may include a communication manager 155. As described in more detail elsewhere herein, the communication manager 155 may transmit configuration information associated with a single DCI communication scheduling multiple PDSCH receptions, wherein the configuration information is associated with a first SBFD configuration and a second SBFD configuration, the first SBFD configuration indicating that communications by a UE are restricted to only one of SBFD symbols or non-SBFD symbols across a plurality of slots and the second SBFD configuration indicating that communications by the UE can be performed in both the SBFD symbols and the non-SBFD symbols across the plurality of slots, wherein the configuration information further indicates for the UE to transmit HARQ information associated with a first HARQ type or a second HARQ type based at least in part on whether the UE is provided with at least one of time domain bundling information or HARQ bundling group information and based at least in part on whether the UE is provided with spatial bundling information; transmit DCI that schedules the multiple PDSCH receptions; and receive HARQ information based at least in part on whether the UE is provided with the time domain bundling information or the HARQ bundling group information and based at least in part on whether the UE is provided with the spatial bundling information. Additionally, or alternatively, the communication manager 155 may perform one or more other operations described herein.

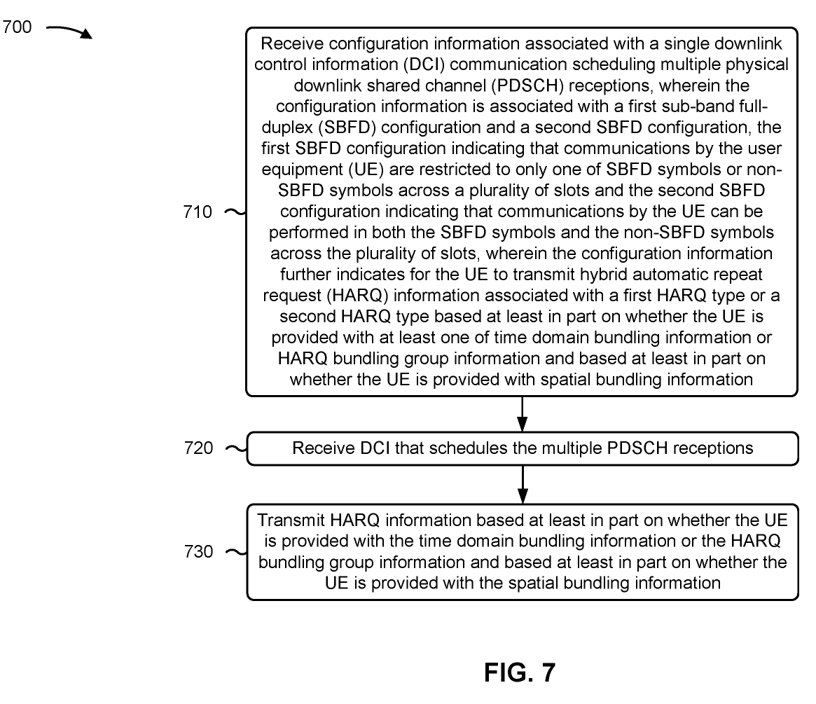

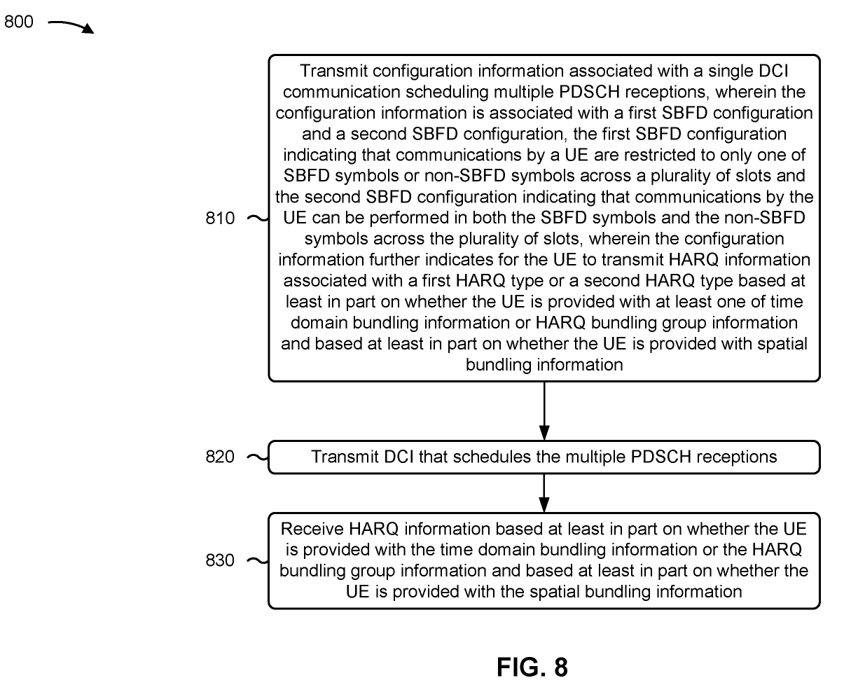

The network node 110, the processing system 145 of the network node 110, the UE 120, the processing system 140 of the UE 120, or any other component(s) of FIG. 1 may implement one or more techniques or perform one or more operations associated with HARQ communications, as described in more detail elsewhere herein. For example, the processing system 145 of the network node 110, or the processing system 140 of the UE 120 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 700 of FIG. 7, process 800 of FIG. 8, or other processes as described herein. In some examples, executing instructions may include running the instructions, converting the instructions, compiling the instructions, or interpreting the instructions, among other examples.

In some aspects, the UE 120 includes means for receiving configuration information associated with a single DCI communication scheduling multiple PDSCH receptions, wherein the configuration information is associated with a first SBFD configuration and a second SBFD configuration, the first SBFD configuration indicating that communications by the UE 120 are restricted to only one of SBFD symbols or non-SBFD symbols across a plurality of slots and the second SBFD configuration indicating that communications by the UE 120 can be performed in both the SBFD symbols and the non-SBFD symbols across the plurality of slots, wherein the configuration information further indicates for the UE 120 to transmit HARQ information associated with a first HARQ type or a second HARQ type based at least in part on whether the UE 120 is provided with at least one of time domain bundling information or HARQ bundling group information and based at least in part on whether the UE 120 is provided with spatial bundling information; means for receiving DCI that schedules the multiple PDSCH receptions; or means for transmitting HARQ information based at least in part on whether the UE 120 is provided with the time domain bundling information or the HARQ bundling group information and based at least in part on whether the UE 120 is provided with the spatial bundling information. The means for the UE 120 to perform operations described herein may include, for example, one or more of communication manager 150, processing system 140, a radio, one or more RF chains, one or more transceivers, one or more antennas, one or more modems, a reception component, or a transmission component, among other examples.

In some aspects, the network node 110 includes means for transmitting configuration information associated with a single DCI communication scheduling multiple PDSCH receptions, wherein the configuration information is associated with a first SBFD configuration and a second SBFD configuration, the first SBFD configuration indicating that communications by a UE are restricted to only one of SBFD symbols or non-SBFD symbols across a plurality of slots and the second SBFD configuration indicating that communications by the UE can be performed in both the SBFD symbols and the non-SBFD symbols across the plurality of slots, wherein the configuration information further indicates for the UE to transmit HARQ information associated with a first HARQ type or a second HARQ type based at least in part on whether the UE is provided with at least one of time domain bundling information or HARQ bundling group information and based at least in part on whether the UE is provided with spatial bundling information; means for transmitting DCI that schedules the multiple PDSCH receptions; or means for receiving HARQ information based at least in part on whether the UE is provided with the time domain bundling information or the HARQ bundling group information and based at least in part on whether the UE is provided with the spatial bundling information. The means for the network node 110 to perform operations described herein may include, for example, one or more of communication manager 155, processing system 145, a radio, one or more RF chains, one or more transceivers, one or more antennas, one or more modems, a reception component, or a transmission component, among other examples.

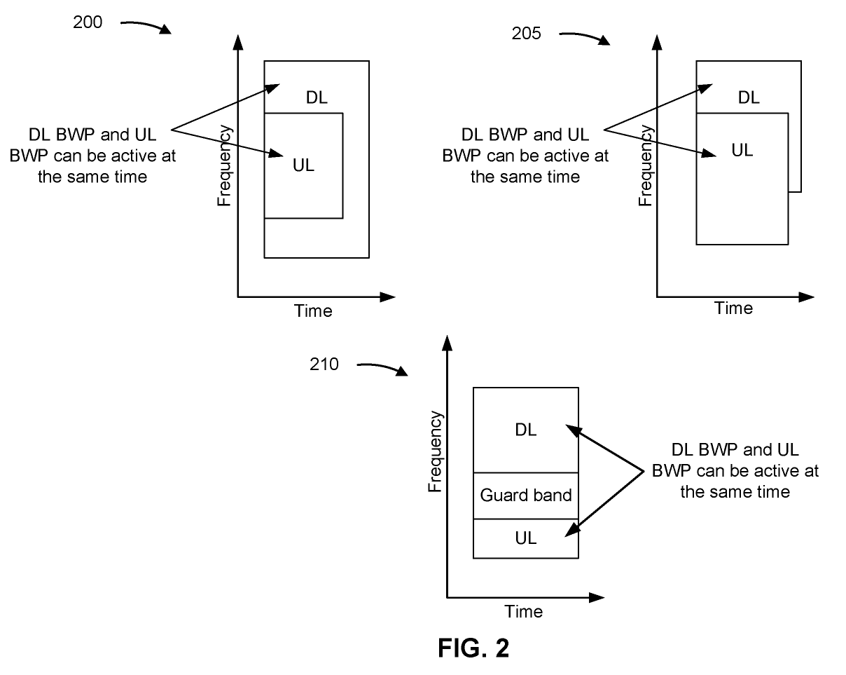

FIG. 2 is a diagram illustrating examples 200, 205, and 210 of full-duplex communication in a wireless network. “Full-duplex communication” in a wireless network refers to simultaneous bi-directional communication between devices in the wireless network. For example, a UE operating in a full-duplex mode may transmit an uplink communication and receive a downlink communication at the same time (e.g., in the same slot or the same symbol). “Half-duplex communication” in a wireless network refers to unidirectional communications (e.g., only downlink communication or only uplink communication) between devices at a given time (e.g., in a given slot or a given symbol).

As shown in FIG. 2, examples 200 and 205 show examples of in-band full-duplex (IBFD) communication. In IBFD, a UE may transmit an uplink communication to a network node and receive a downlink communication from the network node on the same time and frequency resources. As shown in example 200, in a first example of IBFD, the time and frequency resources for uplink communication may fully overlap with the time and frequency resources for downlink communication. As shown in example 205, in a second example of IBFD, the time and frequency resources for uplink communication may partially overlap with the time and frequency resources for downlink communication.

As further shown in FIG. 2, example 210 shows an example of SBFD communication. In SBFD, a UE may transmit an uplink communication to a network node and receive a downlink communication from the network node at the same time, but on different frequency resources. For example, the different frequency resources may be sub-bands of a frequency band, such as a time division duplexing band. In this case, the frequency resources used for downlink communication may be separated from the frequency resources used for uplink communication, in the frequency domain, by a guard band.

As indicated above, FIG. 2 is provided as an example. Other examples may differ from what is described with respect to FIG. 2.

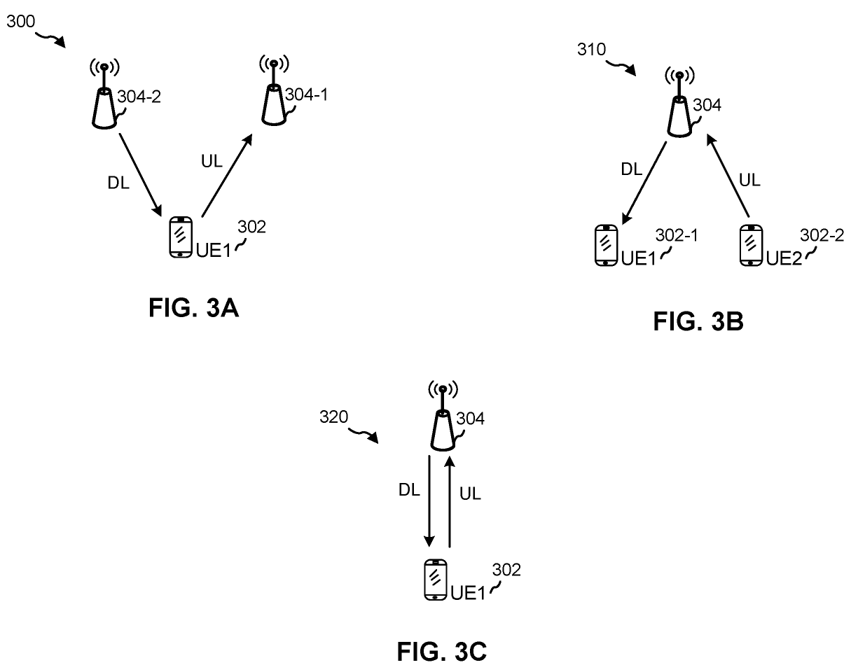

FIGS. 3A-3C are diagrams illustrating examples 300, 310, 320 of full duplex (FD) communication. The example 300 of FIG. 3A includes a UE1 302 and two network nodes (e.g., TRPs) 304-1, 304-2, where the UE1 302 is sending UL transmissions to network node 304-1 and is receiving DL transmissions from network node 304-2. In the example 300 of FIG. 3A, FD is enabled for the UE1 302, but not for the network nodes 304-1, 304-2. The example 310 of FIG. 3B includes two UEs, shown as UE1 302-1 and UE2 302-2, and a network node 304, where the UE1 302-1 is receiving a DL transmission from the network node 304 and the UE2 302-2 is transmitting an UL transmission to the network node 304. In the example 310 of FIG. 3B, FD is enabled for the network node 304, but not for UE1 302-1 and UE2 302-2. The example 320 of FIG. 3C includes a UE1 302 and a network node 304, where the UE1 302 is receiving a DL transmission from the network node 304 and the UE1 302 is transmitting an UL transmission to the network node 304. In the example 320 of FIG. 3C, FD is enabled for both the UE1 302 and the network node 304.

As indicated above, FIGS. 3A-3C are provided as one or more examples. Other examples may differ from what is described with regard to FIGS. 3A-3C.

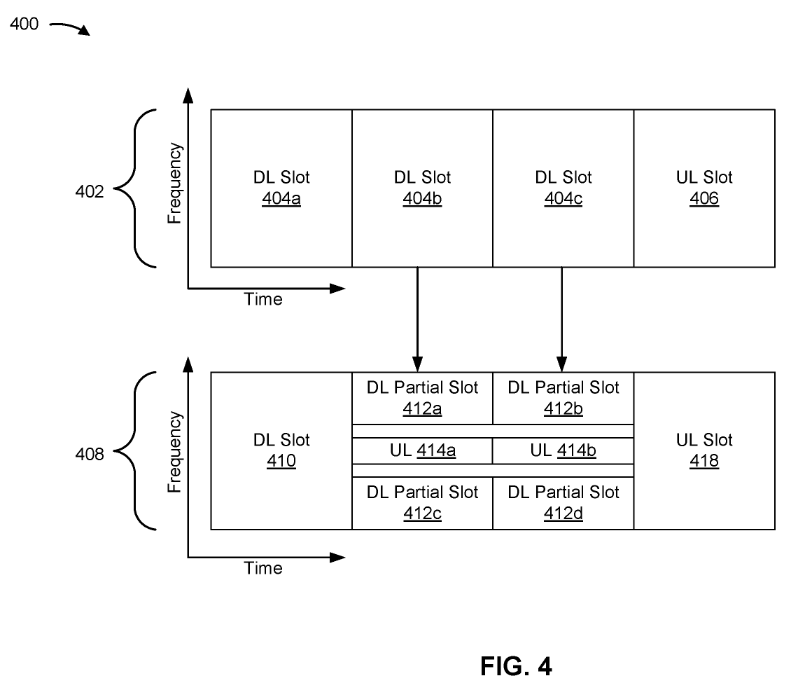

FIG. 4 is a diagram illustrating an example 400 of sub-band full duplex activation. As shown in FIG. 4, example 400 includes a first configuration 402. In some aspects, the first configuration 402 may indicate a first slot format pattern (sometimes called a time-division duplexing (TDD) pattern) associated with a half-duplex mode or a full-duplex mode. The first slot format pattern may include a quantity of downlink slots (e.g., three downlink slots 404a, 404b, and 404c, as shown), a quantity of flexible (FL) slots (not shown), or a quantity of uplink slots (e.g., one uplink slot 406, as shown). The first slot format pattern may repeat over time. In some aspects, a network node 110 may indicate the first slot format pattern to a UE 120 using one or more slot format indicators. A slot format indicator, for a slot, may indicate whether that slot is an uplink slot, a downlink slot, or a flexible slot, among other examples.

A network node 110 may instruct (e.g., using an indication, such as a radio resource control (RRC) message, a medium access control (MAC) control element (CE) (MAC-CE), or downlink control information (DCI)) a UE 120 to switch from the first configuration 402 to a second configuration 408. As an alternative, the UE 120 may indicate to the network node 110 that the UE 120 is switching from the first configuration 402 to the second configuration 408. The second configuration 408 may indicate a second slot format pattern that repeats over time, similar to the first slot format pattern. In any of the aspects described above, the UE 120 may switch from the first configuration 402 to the second configuration 408 during a time period (e.g., a quantity of symbols or an amount of time (e.g., in ms)) based at least in part on an indication received from the network node 110 (e.g., before switching back to the first configuration 402). During that time period, the UE 120 may communicate using the second slot format pattern, and then may revert to using the first slot format pattern after the end of the time period. The time period may be indicated by the network node 110 (e.g., in the instruction to switch from the first configuration 402 to the second configuration 408, as described above) or based at least in part on a programmed or otherwise preconfigured rule. For example, the rule may be based at least in part on a table (e.g., defined in 3GPP specifications or another wireless communication standard) that associates different sub-carrier spacings (SCSs) or numerologies (e.g., represented by µ and associated with corresponding SCSs) with corresponding time periods for switching configurations.

In example 400, the second slot format pattern includes two SBFD slots in place of what were downlink slots in the first slot format pattern. The second slot format may include a DL slot 410 and an UL slot 418. In example 400, each SBFD slot includes a partial slot (e.g., a portion or sub-band of a frequency allocated for use by the network node 110 and the UE 120) for downlink (e.g., partial slots 412a, 412b, 412c, and 412d, as shown) and a partial slot for uplink (e.g., partial slots 414a and 414b, as shown). Accordingly, the UE 120 may operate using the second slot format pattern to transmit an uplink communication in an earlier slot (e.g., the second slot in sequence, shown as partial UL slot 414a) as compared to using the first slot format pattern (e.g., the fourth slot in sequence, shown as UL slot 406). Other examples may include additional or alternative changes. For example, the second configuration 408 may indicate an SBFD slot in place of what was an uplink slot in the first configuration 402 (e.g., UL slot 406). In another example, the second configuration 408 may indicate a downlink slot or an uplink slot in place of what was an SBFD slot in the first configuration 402 (not shown in FIG. 4). In yet another example, the second configuration 408 may indicate a downlink slot or an uplink slot in place of what was an uplink slot or a downlink slot, respectively, in the first configuration 402. “SBFD slot” may refer to a slot in which an SBFD format is used. An SBFD format may include a slot format in which full duplex communication is supported (e.g., for both uplink and downlink communications), with one or more frequencies used for an uplink portion of the slot being separated from one or more frequencies used for a downlink portion of the slot by a guard band. In some aspects, the SBFD format may include a single uplink portion and a single downlink portion separated by a guard band. In some aspects, the SBFD format may include multiple downlink portions and a single uplink portion that is separated from the multiple downlink portions by respective guard bands (e.g., as shown in FIG. 4). In some aspects, an SBFD format may include multiple uplink portions and a single downlink portion that is separated from the multiple uplink portions by respective guard bands. In some aspects, the SBFD format may include multiple uplink portions and multiple downlink portions, where each uplink portion is separated from a downlink portion by a guard band. In some aspects, operating using an SBFD mode may include activating or using an FD mode in one or more slots based at least in part on the one or more slots having the SBFD format. A slot may support the SBFD mode if an UL BWP and a DL BWP are permitted to be or are simultaneously active in the slot in an SBFD fashion (e.g., with guard band separation).

By switching from the first configuration 402 to the second configuration 408, the network node 110 and the UE 120 may experience increased quality or reliability of communications. For example, the network node 110 and the UE 120 may experience increased throughput (e.g., using a full-duplex mode), reduced latency (e.g., the UE 120 may be able to transmit an uplink or a downlink communication sooner using the second configuration 408 rather than the first configuration 402), and increased network resource utilization (e.g., by using both the DL BWP and the UL BWP simultaneously instead of only the DL BWP or the UL BWP).

As indicated above, FIG. 4 is provided as an example. Other examples may differ from what is described with respect to FIG. 4.

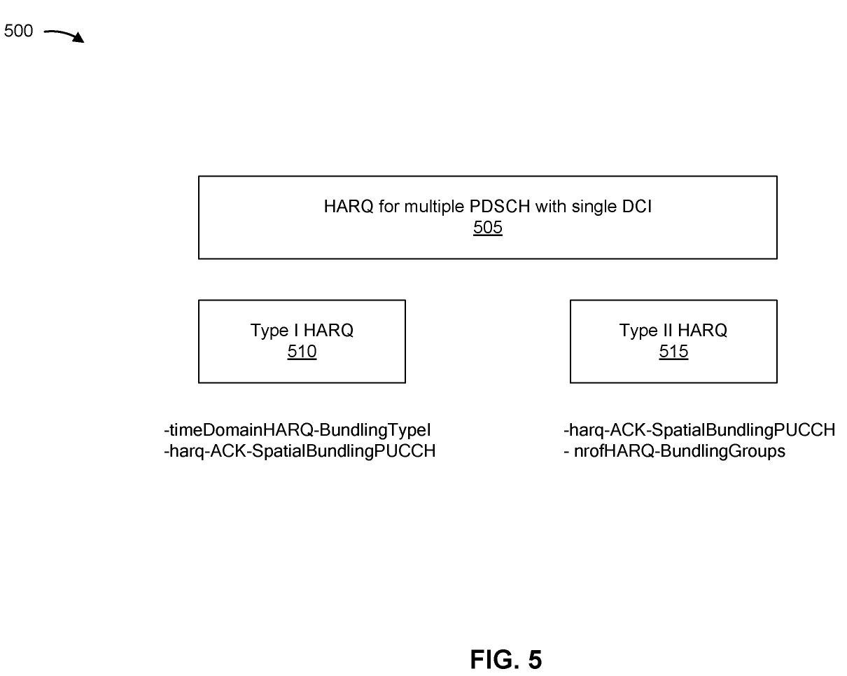

FIG. 5 is a diagram illustrating an example of hybrid automatic repeat request communications.

HARQ is an error correction protocol used in wireless communications to improve the reliability of data transmission. HARQ can combine both forward error correction and automatic repeat request mechanisms and can be used to send redundant information along with the original message such that, if any part of the transmission is received incorrectly, the receiver can use the redundant data to correct the errors. However, if the errors are too significant, the receiver may request a retransmission of the data. HARQ is beneficial in wireless communications due to the unpredictable nature of the wireless channel, where signal degradation, interference, and noise can lead to data corruption. By combining error correction with retransmission requests, HARQ enhances the efficiency of error recovery, ensuring that data is transmitted correctly even in challenging radio environments.

HARQ codebooks may generally be categorized into Type 1 HARQ codebooks or Type 2 HARQ codebooks. The Type 1 HARQ codebook may provide feedback for all potential PDSCH transmissions, regardless of whether the transmissions actually occurred. The Type 1 HARQ codebook may be configured based at least in part on one or more combinations of timing offsets between a PDSCH communication and a corresponding HARQ feedback and one or more time domain resource allocation table entries that define the location and duration of PDSCH transmissions within a slot. This approach may improve robustness by covering all possible transmission opportunities. In contrast, Type 2 dynamic HARQ codebooks may offer a more compact representation by including feedback only for those PDSCH transmissions that were actually carried out. While Type 2 may be more efficient in terms of signaling overhead, Type 1 may provide greater reliability by accounting for a broader set of possible transmission scenarios.

A UE configured to perform uplink transmissions and downlink receptions across SBFD symbols and non-SBFD symbols in different slots (e.g., where each transmission or reception within the slot has either all SBFD symbols or all non-SBFD symbols) may be provided with multiple SBFD configurations. In a first SBFD configuration, the transmissions and receptions by the UE are restricted to the SBFD symbols only or the non-SBFD symbols only. In a second SBFD configuration, the transmissions and receptions may be performed in the SBFD symbols and in the non-SBFD symbols. In some cases, the SBFD-configured UE may be configured with the second SBFD configuration on a per-uplink BWP basis or on a per-downlink BWP basis. The configuration for the downlink BWP may apply to PDSCH receptions within the downlink BWP, while the configuration for the uplink BWP may apply to PUCCH and PUSCH transmissions within the uplink BWP. In some cases, only the first SBFD configuration may be applicable for SRS transmissions. In some cases, the first SBFD configuration may be a default SBFD configuration of the UE, and the second SBFD configuration may be based at least in part on UE capabilities. In some cases, the first SBFD configuration or the second SBFD configuration for the downlink BWP may only apply to PDSCH receptions within the downlink BWP.

In some cases, for the first SBFD configuration, where transmissions and receptions are restricted to only SBFD symbols or only non-SBFD symbols, a valid symbol type may be defined. The valid symbol type for semi-statically configured transmissions and receptions without activation DCI may be explicitly configured by RRC signaling. This may not be applicable to physical downlink control channel (PDCCH) communications. The valid symbol type for dynamically scheduled transmissions and receptions may be determined based at least in part on the symbol type of the first transmission or reception occasion indicated by scheduling sidelink control information (SCI). The first transmission or reception occasion indicated by the scheduling DCI may not be mapped to both SBFD and non-SBFD symbols. The valid symbol type for Type 2 configured grant (CG) PUSCH may be determined based at least in part on the symbol type of the first CG PUSCH associated with activation DCI. The valid symbol type for semi-persistent scheduling (SPS) PDSCH may be determined based at least in part on the symbol type of the first SPS PDSCH associated with activation DCI.

In some cases, certain symbol types (e.g., uplink symbols or downlink symbols) may be excluded from transmission in accordance with one or more exclusion rules. However, these exclusion rules may not be in accordance with whether the first SBFD configuration of the second SBFD configuration is being used by the UE for uplink and downlink transmissions across multiple slots. As shown by reference number 505, when a single DCI message schedules multiple PDSCH receptions by the UE, the UE may be unable to properly determine how to transmit HARQ feedback. For example, the ability of the UE to generate HARQ feedback (e.g., Type I HARQ 510 or Type II HARQ 515) may depend on whether certain information is provided to the UE, such as time domain bundling information (e.g., timeDomainHARQ-BundlingTypeI), HARQ bundling group information (e.g., nrofHARQ-BundlingGroups), or spatial bundling information (e.g., harq-ACK-SpatialBundlingPUCCH).

In some cases, the inability of the UE to properly transmit HARQ feedback may result in the UE transmitting incorrect HARQ feedback, which may lead to repeated retransmissions and increased network latency. In some cases, the inability of the UE to properly transmit HARQ feedback may result in data loss and throughput reduction. For example, failure by the UE to provide accurate HARQ acknowledgments may cause packet losses, reducing the overall system throughput. In some cases, the inability of the UE to properly transmit HARQ feedback may result in increased control signaling overhead. For example, to compensate for HARQ uncertainty, the network may need to transmit additional control information, adding overhead and consuming valuable resources. In some cases, the inability of the UE to properly transmit HARQ feedback may result in improper resource allocation. For example, ambiguity regarding SBFD and non-SBFD slot types may lead to inefficient resource scheduling, potentially underutilizing available bandwidth. In some cases, the inability of the UE to properly transmit HARQ feedback may result in reduced or inconsistent quality of service (QoS). For example, as the UE struggles to determine the correct HARQ configuration, some data streams may experience increased delays or reduced reliability.

As indicated above, FIG. 5 is provided as an example. Other examples may differ from what is described with respect to FIG. 5.

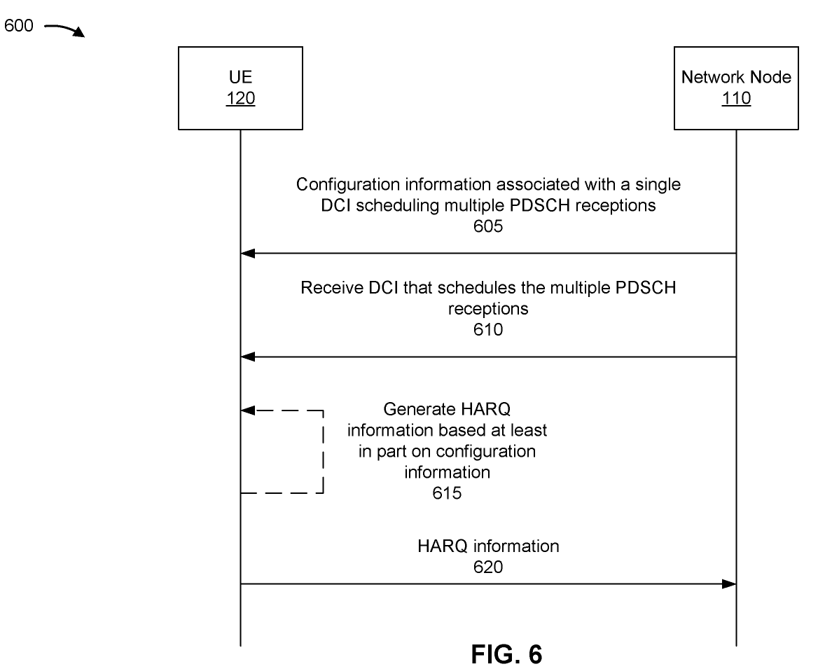

FIG. 6 is a diagram illustrating an example of hybrid automatic repeat request communications.

As shown by reference number 605, the network node 110 may transmit, and the UE 120 may receive, configuration information associated with a single DCI scheduling multiple PDSCH receptions. The configuration information may indicate at least one of a first SBFD configuration or a second SBFD configuration. The first SBFD configuration may indicate that communications by the UE are restricted to only one of SBFD symbols or non-SBFD symbols across a plurality of slots. In contrast, the second SBFD configuration may indicate that communications by the UE can be performed in both the SBFD symbols and the non-SBFD symbols across the plurality of slots. Further, the configuration information may indicate for the UE to transmit HARQ information associated with a first HARQ type (e.g., Type I HARQ) or a second HARQ type (e.g., Type II HARQ) based at least in part on whether the UE is provided with at least one of time domain bundling information (e.g., timeDomainHARQ-BundlingTypeI) or HARQ bundling group information (e.g., nrofHARQ-BundlingGroups) and based at least in part on whether the UE is provided with spatial bundling information (e.g., harq-ACK-SpatialBundlingPUCCH).

As shown by reference number 610, the network node 110 may transmit, and the UE 120 may receive, DCI that schedules the multiple PDSCH receptions. As shown by reference number 615, the UE 120 may generate HARQ information based at least in part on the configuration information. As shown by reference number 620, the UE 120 may transmit, and the network node 110 may receive, the configuration information. Additional details regarding these features are described below.

In a first example, for construction of a HARQ codebook Type I for multiple PDSCH communications scheduled by single DCI where time domain bundling information (e.g., timeDomainHARQ-BundlingType1) is provided and spatial bundling information (harq-Ack-SpatialBundling) is not provided, for a serving cell with SBFD operation in the cell where the UE 120 is provided with the first SBFD configuration per DL BWP (where DL reception is restricted to SBFD symbols only or non-SBFD symbols), a HARQ information bit (HARQ-info bit) of a (first, second) transport block (TB) may be determined by a combination (e.g., a binary AND operation) of the HARQ-ACK information bits of the (first, second) TBs of the received PDSCH communications that do not overlap with an invalid symbol type. When a valid symbol type is indicated as “SBFD” for multiple PDSCH communications by a single DCI, PDSCH communications in non-SBFD symbols (e.g., DL, UL, or FL symbols) may be considered invalid. For a valid symbol type indicated as “non-SBFD” for multiple PDSCH communications by a single DCI, PDSCH communications in SBFD symbols or UL symbols may be considered invalid.

In a second example, for construction of a HARQ codebook Type 1 for multiple PDSCH communications scheduled by a single DCI where time domain bundling information (e.g., timeDomainHARQ-BundlingType1) is provided and spatial bundling information (harq-Ack-SpatialBundling) is provided, for a serving cell with SBFD operation in the cell where the UE 120 is provided with the first SBFD configuration per DL BWP (wherein DL reception is restricted to SBFD symbols only or non-SBFD symbols), the HARQ-info bit may be determined by a combination (e.g., a binary AND operation) of the HARQ-ACK information bits of all TBs of received PDSCH communications that do not overlap with an “invalid” symbol type. When a valid symbol type is indicated as “SBFD” for multiple PDSCHs by a single DCI, PDSCH communications in non-SBFD symbols (e.g., DL, UL or FL symbols) may be considered invalid. For a valid symbol type indicated as “non-SBFD” for multiple PDSCH communications by the single DCI, PDSCH communications in SBFD symbols or UL symbols may be considered invalid.

In a third example, for construction of a HARQ codebook Type 2 for multiple PDSCH communications scheduled by a single DCI where HARQ bundling group information (nrofHARQ-BundlingGroups) is provided and spatial bundling information (harq-Ack-SpatialBundling) is not provided, for a serving cell with SBFD operation in the cell where the UE 120 is provided with the first SBFD configuration per DL BWP (where DL reception is restricted to SBFD symbols only or non-SBFD symbols), for a transport block group (TPG) reception associated with at least one PDSCH communication not overlapping with an UL symbol and not overlapping with an invalid symbol type, the UE 120 may determine that the TB(s) of a PDSCH communications overlapping with an UL symbol, the TB(s) of an “SBFD-specific” PDSCH communication overlapping with invalid non-SBFD symbol type, or the TB(s) of a “non-SBFD-specific” PDSCH overlapping with invalid SBFD symbol type have been properly received. In this example, for a transport block group (TBG) associated only with PDSCH communications overlapping with an UL symbol or PDSCH communications overlapping with an invalid symbol type, the UE 120 may generate a NACK value for the TBG. In some examples, the UE 120 may generate HARQ information bits for a first TB and a second TB separately.

In a fourth example, for construction of a HARQ codebook Type 2 for multiple PDSCH communications scheduled by a single DCI where HARQ bundling group information (nrofHARQ-BundlingGroups) is provided and spatial bundling information (harq-Ack-SpatialBundling) is provided, for a serving cell with SBFD operation in the cell where the UE 120 is provided with the first SBFD configuration per DL BWP (where DL reception is restricted to SBFD symbols only or non-SBFD symbols), for a PDSCH reception not overlapping with an UL symbol and not overlapping with an invalid symbol type, the UE 120 may determine that the TB(s) of a PDSCH communications overlapping with an UL symbol, the TB(s) of an “SBFD-specific” PDSCH communication overlapping with invalid non-SBFD symbol type, or the TB(s) of a “non-SBFD-specific” PDSCH overlapping with invalid SBFD symbol type have been properly received. In this example, for a TBG associated only with PDSCH communications overlapping with an UL symbol or PDSCH communications overlapping with an invalid symbol type, the UE 120 may generate a NACK value for the TBG.

In a fifth example, for construction of a HARQ codebook Type 2 for multiple PDSCH communications scheduled by a single DCI where HARQ bundling group information (nrofHARQ-BundlingGroups) is not provided and spatial bundling information (harq-Ack-SpatialBundling) is not provided, for a serving cell with SBFD operation in the cell where the UE 120 is provided with the first SBFD configuration per DL BWP (where DL reception is restricted to SBFD symbols only or non-SBFD symbols), when a valid symbol type is indicated as “SBFD” for multiple PDSCH communications by the single DCI, for a PDSCH overlapping with a non-SBFD symbol, the UE 120 may generate a NACK for the first TB and may generate a NACK for the second TB (if applicable). When the valid symbol type is determined as “non-SBFD” for multiple PDSCH communications by the single DCI, for a PDSCH communication overlapping with an SBFD symbol or PDSCH communication overlapping with an UL symbol, the UE 120 may generate a NACK for the first TB and may generate a NACK for the second TB (if applicable). In general, for a PDSCH communication overlapping with an invalid symbol type, the UE 120 generates a NACK.

In a sixth example, for construction of a HARQ codebook Type 2 for multiple PDSCH communications scheduled by a single DCI where HARQ bundling group information (nrofHARQ-BundlingGroups) is not provided and spatial bundling information (harq-Ack-SpatialBundling) is provided, for a serving cell with SBFD operation in the cell where the UE 120 is provided with the first SBFD configuration per DL BWP (where DL reception is restricted to SBFD symbols only or non-SBFD symbols), the UE 120 may generate HARQ-ACK information bits for the PDSCH receptions in the ascending order of the starting PDSCH receptions after performing a combination (e.g., a binary AND operation) of the HARQ-ACK information bits of the first and second TB of each PDSCH reception. For PDSCH receptions overlapping with UL or invalid symbols, when a valid symbol type is indicated as “SBFD” for multiple PDSCH communications by the single DCI, for a PDSCH communication overlapping with a non-SBFD symbol, the UE 120 may generate a NACK for the PDSCH reception. When the valid symbol type is indicated as “non-SBFD” for multiple PDSCH communications by the single DCI, for a PDSCH communication overlapping with an SBFD symbol or a PDSCH communication overlapping with an UL symbol, the UE 120 may generate a NACK for the PDSCH reception. In general, for a PDSCH communication overlapping with an invalid symbol type, the UE 120 generates a NACK.

As indicated above, FIG. 6 is provided as an example. Other examples may differ from what is described with respect to FIG. 6.

FIG. 7 is a diagram illustrating an example process 700 performed, for example, at a UE or an apparatus of a UE. Example process 700 is an example where the apparatus or the UE (e.g., UE 120) performs operations associated with hybrid automatic repeat request communication.

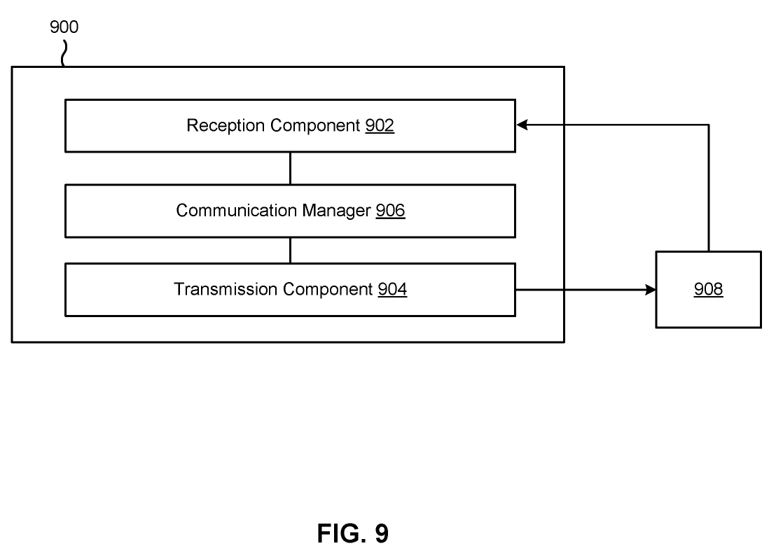

As shown in FIG. 7, in some aspects, process 700 may include receiving configuration information associated with a single DCI communication scheduling multiple PDSCH receptions, wherein the configuration information is associated with a first SBFD configuration and a second SBFD configuration, the first SBFD configuration indicating that communications by the UE are restricted to only one of SBFD symbols or non-SBFD symbols across a plurality of slots and the second SBFD configuration indicating that communications by the UE can be performed in both the SBFD symbols and the non-SBFD symbols across the plurality of slots, wherein the configuration information further indicates for the UE to transmit HARQ information associated with a first HARQ type or a second HARQ type based at least in part on whether the UE is provided with at least one of time domain bundling information or HARQ bundling group information and based at least in part on whether the UE is provided with spatial bundling information (block 710). For example, the UE (e.g., using reception component 902 or communication manager 906, depicted in FIG. 9) may receive configuration information associated with a single DCI communication scheduling multiple PDSCH receptions, wherein the configuration information is associated with a first SBFD configuration and a second SBFD configuration, the first SBFD configuration indicating that communications by the UE are restricted to only one of SBFD symbols or non-SBFD symbols across a plurality of slots and the second SBFD configuration indicating that communications by the UE can be performed in both the SBFD symbols and the non-SBFD symbols across the plurality of slots, wherein the configuration information further indicates for the UE to transmit HARQ information associated with a first HARQ type or a second HARQ type based at least in part on whether the UE is provided with at least one of time domain bundling information or HARQ bundling group information and based at least in part on whether the UE is provided with spatial bundling information, as described above.

As further shown in FIG. 7, in some aspects, process 700 may include receiving DCI that schedules the multiple PDSCH receptions (block 720). For example, the UE (e.g., using reception component 902 or communication manager 906, depicted in FIG. 9) may receive DCI that schedules the multiple PDSCH receptions, as described above.

As further shown in FIG. 7, in some aspects, process 700 may include transmitting HARQ information based at least in part on whether the UE is provided with the time domain bundling information or the HARQ bundling group information and based at least in part on whether the UE is provided with the spatial bundling information (block 730). For example, the UE (e.g., using transmission component 904 or communication manager 906, depicted in FIG. 9) may transmit HARQ information based at least in part on whether the UE is provided with the time domain bundling information or the HARQ bundling group information and based at least in part on whether the UE is provided with the spatial bundling information, as described above.

Process 700 may include additional aspects, such as any single aspect or any combination of aspects described below or in connection with one or more other processes described elsewhere herein.

In a first aspect, the first HARQ type is Type I HARQ codebook, the second HARQ type is Type II HARQ codebook, the time domain bundling information is a time domain HARQ bundling Type I indicator, the HARQ bundling group information is a number of HARQ bundling groups indicator, and the spatial bundling information is a HARQ acknowledgement spatial bundling physical uplink control channel indicator.

In a second aspect, alone or in combination with the first aspect, the HARQ information is associated with the first HARQ type based at least in part on the UE being provided with the time domain bundling information, based at least in part on the UE not being provided with the spatial bundling information, and based at least in part on the UE being provided with the first SBFD configuration for a downlink bandwidth part of a plurality of downlink bandwidth parts from a network node configured for SBFD operations.

In a third aspect, alone or in combination with one or more of the first and second aspects, a HARQ information bit included in a transport block is based at least in part on a combination operation of two or more HARQ acknowledgement information bits included in two or more PDSCH receptions of the multiple PDSCH receptions that do not overlap with an invalid symbol type.

In a fourth aspect, alone or in combination with one or more of the first through third aspects, a PDSCH reception included in a non-SBFD symbol is invalid based at least in part on a valid symbol type being indicated as SBFD in the DCI.

In a fifth aspect, alone or in combination with one or more of the first through fourth aspects, a PDSCH reception included in an SBFD symbol or in an uplink symbol is invalid based at least in part on a valid symbol type being indicated as non-SBFD in the DCI.

In a sixth aspect, alone or in combination with one or more of the first through fifth aspects, the HARQ information is associated with the first HARQ type based at least in part on the UE being provided with the time domain bundling information, based at least in part on the UE being provided with the spatial bundling information, and based at least in part on the UE being provided with the first SBFD configuration for a downlink bandwidth part of a plurality of downlink bandwidth parts from a network node configured for SBFD operations.

In a seventh aspect, alone or in combination with one or more of the first through sixth aspects, a HARQ information bit included in a transport block is based at least in part on a combination operation of two or more HARQ acknowledgement information bits included in two or more PDSCH receptions of the multiple PDSCH receptions that do not overlap with an invalid symbol type.

In an eighth aspect, alone or in combination with one or more of the first through seventh aspects, a PDSCH reception included in a non-SBFD symbol is invalid based at least in part on a valid symbol type being indicated as SBFD in the DCI.

In a ninth aspect, alone or in combination with one or more of the first through eighth aspects, a PDSCH reception included in an SBFD symbol or in an uplink symbol is invalid based at least in part on a valid symbol type being indicated as non-SBFD in the DCI.

In a tenth aspect, alone or in combination with one or more of the first through ninth aspects, the HARQ information is associated with the second HARQ type based at least in part on the UE being provided with the HARQ bundling group information, based at least in part on the UE not being provided with the spatial bundling information, and based at least in part on the UE being provided with the first SBFD configuration for a downlink bandwidth part of a plurality of downlink bandwidth parts from a network node configured for SBFD operations.

In an eleventh aspect, alone or in combination with one or more of the first through tenth aspects, process 700 includes processing at least one of a transport block of a PDSCH reception overlapping with an uplink symbol, a transport block of an SBFD-specific PDSCH reception overlapping with an invalid non-SBFD symbol type, or a transport block of a non-SBFD-specific PDSCH reception overlapping with an invalid SBFD symbol type based at least in part on a transport block group associated with at least one PDSCH reception not overlapping with an uplink symbol and not overlapping with an invalid symbol type.

In a twelfth aspect, alone or in combination with one or more of the first through eleventh aspects, process 700 includes transmitting a negative acknowledgement message for a transport block group based at least in part on the transport block group being associated with a PDSCH reception that overlaps with an uplink symbol or being associated with a PDSCH reception that overlaps with an invalid symbol type.

In a thirteenth aspect, alone or in combination with one or more of the first through twelfth aspects, the HARQ information is associated with the second HARQ type based at least in part on the UE being provided with the HARQ bundling group information, based at least in part on the UE being provided with the spatial bundling information, and based at least in part on the UE being provided with the first SBFD configuration for a downlink bandwidth part of a plurality of downlink bandwidth parts from a network node configured for SBFD operations.

In a fourteenth aspect, alone or in combination with one or more of the first through thirteenth aspects, process 700 includes processing at least one of a transport block of a PDSCH reception overlapping with an uplink symbol, a transport block of an SBFD-specific PDSCH reception overlapping with an invalid non-SBFD symbol type, or a transport block of a non-SBFD-specific PDSCH reception overlapping with an invalid SBFD symbol type based at least in part on a transport block group associated with at least one PDSCH reception not overlapping with an uplink symbol and not overlapping with an invalid symbol type.

In a fifteenth aspect, alone or in combination with one or more of the first through fourteenth aspects, process 700 includes transmitting a negative acknowledgement message for a transport block group based at least in part on the transport block group being associated with a PDSCH reception that overlaps with an uplink symbol or being associated with a PDSCH reception that overlaps with an invalid symbol type.

In a sixteenth aspect, alone or in combination with one or more of the first through fifteenth aspects, the HARQ information is associated with the second HARQ type based at least in part on the UE not being provided with the HARQ bundling group information, based at least in part on the UE not being provided with the spatial bundling information, and based at least in part on the UE being provided with the first SBFD configuration for a downlink bandwidth part of a plurality of downlink bandwidth parts from a network node configured for SBFD operations.

In a seventeenth aspect, alone or in combination with one or more of the first through sixteenth aspects, process 700 includes transmitting a negative acknowledgement message for at least a first transport block included in a PDSCH reception that overlaps with a non-SBFD symbol based at least in part on a valid symbol type being indicated as SBFD in the DCI.

In an eighteenth aspect, alone or in combination with one or more of the first through seventeenth aspects, process 700 includes transmitting a negative acknowledgement message for at least a first transport block included in a PDSCH reception that overlaps with an SBFD symbol based at least in part on a valid symbol type being indicated as non-SBFD in the DCI.

In a nineteenth aspect, alone or in combination with one or more of the first through eighteenth aspects, the HARQ information is associated with the second HARQ type based at least in part on the UE not being provided with the HARQ bundling group information, based at least in part on the UE being provided with the spatial bundling information, and based at least in part on the UE being provided with the first SBFD configuration for a downlink bandwidth part of a plurality of downlink bandwidth parts from a network node configured for SBFD operations.

In a twentieth aspect, alone or in combination with one or more of the first through nineteenth aspects, process 700 includes generating a HARQ acknowledgement bit for each PDSCH reception of the multiple PDSCH receptions in ascending order of the PDSCH receptions based at least in part on performing a combination operation of one or more HARQ acknowledgement bits included in a first transport block and one or more HARQ acknowledgement bits included in a second transport block of each PDSCH reception of the multiple PDSCH receptions.

In a twenty-first aspect, alone or in combination with one or more of the first through twentieth aspects, process 700 includes transmitting a negative acknowledgement message for a PDSCH reception that overlaps with a non-SBFD symbol based at least in part on a valid symbol type being indicated as SBFD in the DCI.

In a twenty-second aspect, alone or in combination with one or more of the first through twenty-first aspects, process 700 includes transmitting a negative acknowledgement message for a PDSCH reception that overlaps with an SBFD symbol based at least in part on a valid symbol type being indicated as non-SBFD in the DCI.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node. Example process 800 is an example where the apparatus or the network node (e.g., network node 110) performs operations associated with hybrid automatic repeat request communication.

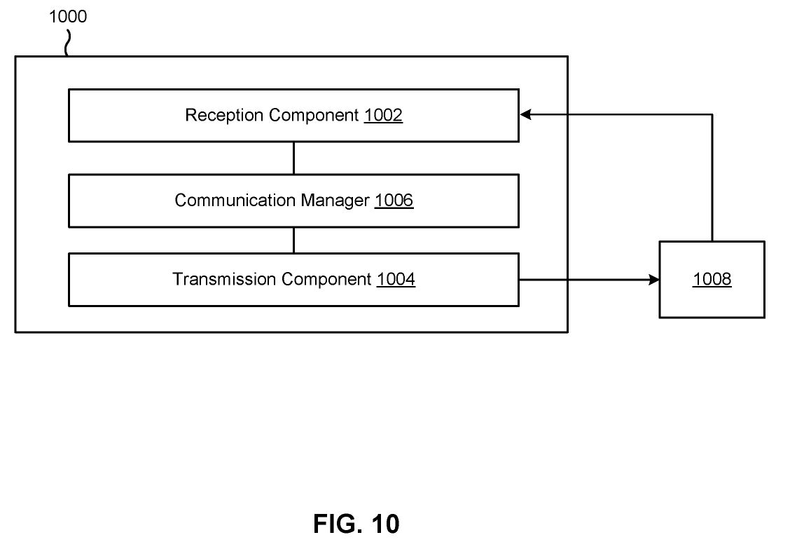

As shown in FIG. 8, in some aspects, process 800 may include transmitting configuration information associated with a single DCI communication scheduling multiple PDSCH receptions, wherein the configuration information is associated with a first SBFD configuration and a second SBFD configuration, the first SBFD configuration indicating that communications by a UE are restricted to only one of SBFD symbols or non-SBFD symbols across a plurality of slots and the second SBFD configuration indicating that communications by the UE can be performed in both the SBFD symbols and the non-SBFD symbols across the plurality of slots, wherein the configuration information further indicates for the UE to transmit HARQ information associated with a first HARQ type or a second HARQ type based at least in part on whether the UE is provided with at least one of time domain bundling information or HARQ bundling group information and based at least in part on whether the UE is provided with spatial bundling information (block 810). For example, the network node (e.g., using transmission component 1004 or communication manager 1006, depicted in FIG. 10) may transmit configuration information associated with a single DCI communication scheduling multiple PDSCH receptions, wherein the configuration information is associated with a first SBFD configuration and a second SBFD configuration, the first SBFD configuration indicating that communications by a UE are restricted to only one of SBFD symbols or non-SBFD symbols across a plurality of slots and the second SBFD configuration indicating that communications by the UE can be performed in both the SBFD symbols and the non-SBFD symbols across the plurality of slots, wherein the configuration information further indicates for the UE to transmit HARQ information associated with a first HARQ type or a second HARQ type based at least in part on whether the UE is provided with at least one of time domain bundling information or HARQ bundling group information and based at least in part on whether the UE is provided with spatial bundling information, as described above.

As further shown in FIG. 8, in some aspects, process 800 may include transmitting DCI that schedules the multiple PDSCH receptions (block 820). For example, the network node (e.g., using transmission component 1004 or communication manager 1006, depicted in FIG. 10) may transmit DCI that schedules the multiple PDSCH receptions, as described above.

As further shown in FIG. 8, in some aspects, process 800 may include receiving HARQ information based at least in part on whether the UE is provided with the time domain bundling information or the HARQ bundling group information and based at least in part on whether the UE is provided with the spatial bundling information (block 830). For example, the network node (e.g., using reception component 1002 or communication manager 1006, depicted in FIG. 10) may receive HARQ information based at least in part on whether the UE is provided with the time domain bundling information or the HARQ bundling group information and based at least in part on whether the UE is provided with the spatial bundling information, as described above.

Process 800 may include additional aspects, such as any single aspect or any combination of aspects described below or in connection with one or more other processes described elsewhere herein.

In a first aspect, the first HARQ type is Type I HARQ codebook, the second HARQ type is Type II HARQ codebook, the time domain bundling information is a time domain HARQ bundling Type I indicator, the HARQ bundling group information is a number of HARQ bundling groups indicator, and the spatial bundling information is a HARQ acknowledgement spatial bundling physical uplink control channel indicator.

In a second aspect, alone or in combination with the first aspect, the HARQ information is associated with the first HARQ type based at least in part on the UE being provided with the time domain bundling information, based at least in part on the UE not being provided with the spatial bundling information, and based at least in part on the UE being provided with the first SBFD configuration for a downlink bandwidth part of a plurality of downlink bandwidth parts from a network node configured for SBFD operations.

In a third aspect, alone or in combination with one or more of the first and second aspects, a HARQ information bit included in a transport block is based at least in part on a combination operation of two or more HARQ acknowledgement information bits included in two or more PDSCH receptions of the multiple PDSCH receptions that do not overlap with an invalid symbol type.

In a fourth aspect, alone or in combination with one or more of the first through third aspects, a PDSCH reception included in a non-SBFD symbol is invalid based at least in part on a valid symbol type being indicated as SBFD in the DCI.

In a fifth aspect, alone or in combination with one or more of the first through fourth aspects, a PDSCH reception included in an SBFD symbol or in an uplink symbol is invalid based at least in part on a valid symbol type being indicated as non-SBFD in the DCI.

In a sixth aspect, alone or in combination with one or more of the first through fifth aspects, the HARQ information is associated with the first HARQ type based at least in part on the UE being provided with the time domain bundling information, based at least in part on the UE being provided with the spatial bundling information, and based at least in part on the UE being provided with the first SBFD configuration for a downlink bandwidth part of a plurality of downlink bandwidth parts from a network node configured for SBFD operations.

In a seventh aspect, alone or in combination with one or more of the first through sixth aspects, a HARQ information bit included in a transport block is based at least in part on a combination operation of two or more HARQ acknowledgement information bits included in two or more PDSCH receptions of the multiple PDSCH receptions that do not overlap with an invalid symbol type.

In an eighth aspect, alone or in combination with one or more of the first through seventh aspects, a PDSCH reception included in a non-SBFD symbol is invalid based at least in part on a valid symbol type being indicated as SBFD in the DCI.

In a ninth aspect, alone or in combination with one or more of the first through eighth aspects, a PDSCH reception included in an SBFD symbol or in an uplink symbol is invalid based at least in part on a valid symbol type being indicated as non-SBFD in the DCI.

In a tenth aspect, alone or in combination with one or more of the first through ninth aspects, the HARQ information is associated with the second HARQ type based at least in part on the UE being provided with the HARQ bundling group information, based at least in part on the UE not being provided with the spatial bundling information, and based at least in part on the UE being provided with the first SBFD configuration for a downlink bandwidth part of a plurality of downlink bandwidth parts from a network node configured for SBFD operations.

In an eleventh aspect, alone or in combination with one or more of the first through tenth aspects, the configuration information indicates for the UE to process at least one of a transport block of a PDSCH reception overlapping with an uplink symbol, a transport block of an SBFD-specific PDSCH reception overlapping with an invalid non-SBFD symbol type, or a transport block of a non-SBFD-specific PDSCH reception overlapping with an invalid SBFD symbol type based at least in part on a transport block group associated with at least one PDSCH reception not overlapping with an uplink symbol and not overlapping with an invalid symbol type.

In a twelfth aspect, alone or in combination with one or more of the first through eleventh aspects, process 800 includes receiving a negative acknowledgement message for a transport block group based at least in part on the transport block group being associated with a PDSCH reception that overlaps with an uplink symbol or being associated with a PDSCH reception that overlaps with an invalid symbol type.

In a thirteenth aspect, alone or in combination with one or more of the first through twelfth aspects, the HARQ information is associated with the second HARQ type based at least in part on the UE being provided with the HARQ bundling group information, based at least in part on the UE being provided with the spatial bundling information, and based at least in part on the UE being provided with the first SBFD configuration for a downlink bandwidth part of a plurality of downlink bandwidth parts from a network node configured for SBFD operations.

In a fourteenth aspect, alone or in combination with one or more of the first through thirteenth aspects, the configuration information indicates for the UE to process at least one of a transport block of a PDSCH reception overlapping with an uplink symbol, a transport block of an SBFD-specific PDSCH reception overlapping with an invalid non-SBFD symbol type, or a transport block of a non-SBFD-specific PDSCH reception overlapping with an invalid SBFD symbol type based at least in part on a transport block group associated with at least one PDSCH reception not overlapping with an uplink symbol and not overlapping with an invalid symbol type.

In a fifteenth aspect, alone or in combination with one or more of the first through fourteenth aspects, process 800 includes receiving a negative acknowledgement message for a transport block group based at least in part on the transport block group being associated with a PDSCH reception that overlaps with an uplink symbol or being associated with a PDSCH reception that overlaps with an invalid symbol type.

In a sixteenth aspect, alone or in combination with one or more of the first through fifteenth aspects, the HARQ information is associated with the second HARQ type based at least in part on the UE not being provided with the HARQ bundling group information, based at least in part on the UE not being provided with the spatial bundling information, and based at least in part on the UE being provided with the first SBFD configuration for a downlink bandwidth part of a plurality of downlink bandwidth parts from a network node configured for SBFD operations.

In a seventeenth aspect, alone or in combination with one or more of the first through sixteenth aspects, process 800 includes receiving a negative acknowledgement message for at least a first transport block included in a PDSCH reception that overlaps with a non-SBFD symbol based at least in part on a valid symbol type being indicated as SBFD in the DCI.

In an eighteenth aspect, alone or in combination with one or more of the first through seventeenth aspects, process 800 includes receiving a negative acknowledgement message for at least a first transport block included in a PDSCH reception that overlaps with an SBFD symbol based at least in part on a valid symbol type being indicated as non-SBFD in the DCI.

In a nineteenth aspect, alone or in combination with one or more of the first through eighteenth aspects, the HARQ information is associated with the second HARQ type based at least in part on the UE not being provided with the HARQ bundling group information, based at least in part on the UE being provided with the spatial bundling information, and based at least in part on the UE being provided with the first SBFD configuration for a downlink bandwidth part of a plurality of downlink bandwidth parts from a network node configured for SBFD operations.

In a twentieth aspect, alone or in combination with one or more of the first through nineteenth aspects, the configuration information indicates for the UE to generate a HARQ acknowledgement bit for each PDSCH reception of the multiple PDSCH receptions in ascending order of the PDSCH receptions based at least in part on performing a combination operation of one or more HARQ acknowledgement bits included in a first transport block and one or more HARQ acknowledgement bits included in a second transport block of each PDSCH reception of the multiple PDSCH receptions.

In a twenty-first aspect, alone or in combination with one or more of the first through twentieth aspects, process 800 includes receiving a negative acknowledgement message for a PDSCH reception that overlaps with a non-SBFD symbol based at least in part on a valid symbol type being indicated as SBFD in the DCI.

In a twenty-second aspect, alone or in combination with one or more of the first through twenty-first aspects, process 800 includes receiving a negative acknowledgement message for a PDSCH reception that overlaps with an SBFD symbol based at least in part on a valid symbol type being indicated as non-SBFD in the DCI.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIG. 6. Additionally, or alternatively, the apparatus 900 may be configured to perform one or more processes described herein, such as process 700 of FIG. 7. In some aspects, the apparatus 900 or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The reception component 902 may receive configuration information associated with a single DCI communication scheduling multiple PDSCH receptions, wherein the configuration information is associated with a first SBFD configuration and a second SBFD configuration, the first SBFD configuration indicating that communications by the UE are restricted to only one of SBFD symbols or non-SBFD symbols across a plurality of slots and the second SBFD configuration indicating that communications by the UE can be performed in both the SBFD symbols and the non-SBFD symbols across the plurality of slots, wherein the configuration information further indicates for the UE to transmit HARQ information associated with a first HARQ type or a second HARQ type based at least in part on whether the UE is provided with at least one of time domain bundling information or HARQ bundling group information and based at least in part on whether the UE is provided with spatial bundling information. The reception component 902 may receive DCI that schedules the multiple PDSCH receptions. The transmission component 904 may transmit HARQ information based at least in part on whether the UE is provided with the time domain bundling information or the HARQ bundling group information and based at least in part on whether the UE is provided with the spatial bundling information.

The communication manager 906 may process at least one of a transport block of a PDSCH reception overlapping with an uplink symbol, a transport block of an SBFD-specific PDSCH reception overlapping with an invalid non-SBFD symbol type, or a transport block of a non-SBFD-specific PDSCH reception overlapping with an invalid SBFD symbol type based at least in part on a transport block group associated with at least one PDSCH reception not overlapping with an uplink symbol and not overlapping with an invalid symbol type. The transmission component 904 may transmit a negative acknowledgement message for a transport block group based at least in part on the transport block group being associated with a PDSCH reception that overlaps with an uplink symbol or being associated with a PDSCH reception that overlaps with an invalid symbol type.

The communication manager 906 may process at least one of a transport block of a PDSCH reception overlapping with an uplink symbol, a transport block of an SBFD-specific PDSCH reception overlapping with an invalid non-SBFD symbol type, or a transport block of a non-SBFD-specific PDSCH reception overlapping with an invalid SBFD symbol type based at least in part on a transport block group associated with at least one PDSCH reception not overlapping with an uplink symbol and not overlapping with an invalid symbol type. The transmission component 904 may transmit a negative acknowledgement message for a transport block group based at least in part on the transport block group being associated with a PDSCH reception that overlaps with an uplink symbol or being associated with a PDSCH reception that overlaps with an invalid symbol type. The transmission component 904 may transmit a negative acknowledgement message for at least a first transport block included in a PDSCH reception that overlaps with a non-SBFD symbol based at least in part on a valid symbol type being indicated as SBFD in the DCI.

The transmission component 904 may transmit a negative acknowledgement message for at least a first transport block included in a PDSCH reception that overlaps with an SBFD symbol based at least in part on a valid symbol type being indicated as non-SBFD in the DCI. The communication manager 906 may generate a HARQ acknowledgement bit for each PDSCH reception of the multiple PDSCH receptions in ascending order of the PDSCH receptions based at least in part on performing a combination operation of one or more HARQ acknowledgement bits included in a first transport block and one or more HARQ acknowledgement bits included in a second transport block of each PDSCH reception of the multiple PDSCH receptions. The transmission component 904 may transmit a negative acknowledgement message for a PDSCH reception that overlaps with a non-SBFD symbol based at least in part on a valid symbol type being indicated as SBFD in the DCI. The transmission component 904 may transmit a negative acknowledgement message for a PDSCH reception that overlaps with an SBFD symbol based at least in part on a valid symbol type being indicated as non-SBFD in the DCI.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network node, or a network node may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network node.

In some aspects, the apparatus 1000 may be configured to perform one or more operations described herein in connection with FIG. 6. Additionally, or alternatively, the apparatus 1000 may be configured to perform one or more processes described herein, such as process 800 of FIG. 8. In some aspects, the apparatus 1000 or one or more components shown in FIG. 10 may include one or more components of the network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node described above in connection with FIG. 1, such as a radio, one or more RF chains, one or more transceivers, or one or more modems, each of which may in turn be coupled with one or more antennas of the network node. In some aspects, the reception component 1002 or the transmission component 1004 may include or may be included in a network interface. The network interface may be configured to obtain or output signals for the apparatus 1000 via one or more communications links, such as a backhaul link, a midhaul link, or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

The transmission component 1004 may transmit configuration information associated with a single DCI communication scheduling multiple PDSCH receptions, wherein the configuration information is associated with a first SBFD configuration and a second SBFD configuration, the first SBFD configuration indicating that communications by a UE are restricted to only one of SBFD symbols or non-SBFD symbols across a plurality of slots and the second SBFD configuration indicating that communications by the UE can be performed in both the SBFD symbols and the non-SBFD symbols across the plurality of slots, wherein the configuration information further indicates for the UE to transmit HARQ information associated with a first HARQ type or a second HARQ type based at least in part on whether the UE is provided with at least one of time domain bundling information or HARQ bundling group information and based at least in part on whether the UE is provided with spatial bundling information. The transmission component 1004 may transmit DCI that schedules the multiple PDSCH receptions. The reception component 1002 may receive HARQ information based at least in part on whether the UE is provided with the time domain bundling information or the HARQ bundling group information and based at least in part on whether the UE is provided with the spatial bundling information.

The reception component 1002 may receive a negative acknowledgement message for a transport block group based at least in part on the transport block group being associated with a PDSCH reception that overlaps with an uplink symbol or being associated with a PDSCH reception that overlaps with an invalid symbol type. The reception component 1002 may receive a negative acknowledgement message for a transport block group based at least in part on the transport block group being associated with a PDSCH reception that overlaps with an uplink symbol or being associated with a PDSCH reception that overlaps with an invalid symbol type. The reception component 1002 may receive a negative acknowledgement message for at least a first transport block included in a PDSCH reception that overlaps with a non-SBFD symbol based at least in part on a valid symbol type being indicated as SBFD in the DCI.

The reception component 1002 may receive a negative acknowledgement message for at least a first transport block included in a PDSCH reception that overlaps with an SBFD symbol based at least in part on a valid symbol type being indicated as non-SBFD in the DCI. The reception component 1002 may receive a negative acknowledgement message for a PDSCH reception that overlaps with a non-SBFD symbol based at least in part on a valid symbol type being indicated as SBFD in the DCI. The reception component 1002 may receive a negative acknowledgement message for a PDSCH reception that overlaps with an SBFD symbol based at least in part on a valid symbol type being indicated as non-SBFD in the DCI.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: receiving configuration information associated with a single downlink control information (DCI) communication scheduling multiple physical downlink shared channel (PDSCH) receptions, wherein the configuration information is associated with a first sub-band full-duplex (SBFD) configuration and a second SBFD configuration, the first SBFD configuration indicating that communications by the UE are restricted to only one of SBFD symbols or non-SBFD symbols across a plurality of slots and the second SBFD configuration indicating that communications by the UE can be performed in both the SBFD symbols and the non-SBFD symbols across the plurality of slots, wherein the configuration information further indicates for the UE to transmit hybrid automatic repeat request (HARQ) information associated with a first HARQ type or a second HARQ type based at least in part on whether the UE is provided with at least one of time domain bundling information or HARQ bundling group information and based at least in part on whether the UE is provided with spatial bundling information; receiving DCI that schedules the multiple PDSCH receptions; and transmitting HARQ information based at least in part on whether the UE is provided with the time domain bundling information or the HARQ bundling group information and based at least in part on whether the UE is provided with the spatial bundling information.

Aspect 2: The method of Aspect 1, wherein the first HARQ type is Type I HARQ codebook, the second HARQ type is Type II HARQ codebook, the time domain bundling information is a time domain HARQ bundling Type I indicator, the HARQ bundling group information is a number of HARQ bundling groups indicator, and the spatial bundling information is a HARQ acknowledgement spatial bundling physical uplink control channel indicator.

Aspect 3: The method of any of Aspects 1-2, wherein the HARQ information is associated with the first HARQ type based at least in part on the UE being provided with the time domain bundling information, based at least in part on the UE not being provided with the spatial bundling information, and based at least in part on the UE being provided with the first SBFD configuration for a downlink bandwidth part of a plurality of downlink bandwidth parts from a network node configured for SBFD operations.

Aspect 4: The method of Aspect 3, wherein a HARQ information bit included in a transport block is based at least in part on a combination operation of two or more HARQ acknowledgement information bits included in two or more PDSCH receptions of the multiple PDSCH receptions that do not overlap with an invalid symbol type.

Aspect 5: The method of Aspect 4, wherein a PDSCH reception included in a non-SBFD symbol is invalid based at least in part on a valid symbol type being indicated as SBFD in the DCI.

Aspect 6: The method of Aspect 4, wherein a PDSCH reception included in an SBFD symbol or in an uplink symbol is invalid based at least in part on a valid symbol type being indicated as non-SBFD in the DCI.

Aspect 7: The method of any of Aspects 1-6, wherein the HARQ information is associated with the first HARQ type based at least in part on the UE being provided with the time domain bundling information, based at least in part on the UE being provided with the spatial bundling information, and based at least in part on the UE being provided with the first SBFD configuration for a downlink bandwidth part of a plurality of downlink bandwidth parts from a network node configured for SBFD operations.

Aspect 8: The method of Aspect 7, wherein a HARQ information bit included in a transport block is based at least in part on a combination operation of two or more HARQ acknowledgement information bits included in two or more PDSCH receptions of the multiple PDSCH receptions that do not overlap with an invalid symbol type.

Aspect 9: The method of Aspect 8, wherein a PDSCH reception included in a non-SBFD symbol is invalid based at least in part on a valid symbol type being indicated as SBFD in the DCI.

Aspect 10: The method of Aspect 8, wherein a PDSCH reception included in an SBFD symbol or in an uplink symbol is invalid based at least in part on a valid symbol type being indicated as non-SBFD in the DCI.

Aspect 11: The method of any of Aspects 1-10, wherein the HARQ information is associated with the second HARQ type based at least in part on the UE being provided with the HARQ bundling group information, based at least in part on the UE not being provided with the spatial bundling information, and based at least in part on the UE being provided with the first SBFD configuration for a downlink bandwidth part of a plurality of downlink bandwidth parts from a network node configured for SBFD operations.

Aspect 12: The method of Aspect 11, further comprising processing at least one of a transport block of a PDSCH reception overlapping with an uplink symbol, a transport block of an SBFD-specific PDSCH reception overlapping with an invalid non-SBFD symbol type, or a transport block of a non-SBFD-specific PDSCH reception overlapping with an invalid SBFD symbol type based at least in part on a transport block group associated with at least one PDSCH reception not overlapping with an uplink symbol and not overlapping with an invalid symbol type.

Aspect 13: The method of Aspect 11, further comprising transmitting a negative acknowledgement message for a transport block group based at least in part on the transport block group being associated with a PDSCH reception that overlaps with an uplink symbol or being associated with a PDSCH reception that overlaps with an invalid symbol type.

Aspect 14: The method of any of Aspects 1-13, wherein the HARQ information is associated with the second HARQ type based at least in part on the UE being provided with the HARQ bundling group information, based at least in part on the UE being provided with the spatial bundling information, and based at least in part on the UE being provided with the first SBFD configuration for a downlink bandwidth part of a plurality of downlink bandwidth parts from a network node configured for SBFD operations.

Aspect 15: The method of Aspect 14, further comprising processing at least one of a transport block of a PDSCH reception overlapping with an uplink symbol, a transport block of an SBFD-specific PDSCH reception overlapping with an invalid non-SBFD symbol type, or a transport block of a non-SBFD-specific PDSCH reception overlapping with an invalid SBFD symbol type based at least in part on a transport block group associated with at least one PDSCH reception not overlapping with an uplink symbol and not overlapping with an invalid symbol type.

Aspect 16: The method of Aspect 14, further comprising transmitting a negative acknowledgement message for a transport block group based at least in part on the transport block group being associated with a PDSCH reception that overlaps with an uplink symbol or being associated with a PDSCH reception that overlaps with an invalid symbol type.

Aspect 17: The method of any of Aspects 1-16, wherein the HARQ information is associated with the second HARQ type based at least in part on the UE not being provided with the HARQ bundling group information, based at least in part on the UE not being provided with the spatial bundling information, and based at least in part on the UE being provided with the first SBFD configuration for a downlink bandwidth part of a plurality of downlink bandwidth parts from a network node configured for SBFD operations.

Aspect 18: The method of Aspect 17, further comprising transmitting a negative acknowledgement message for at least a first transport block included in a PDSCH reception that overlaps with a non-SBFD symbol based at least in part on a valid symbol type being indicated as SBFD in the DCI.

Aspect 19: The method of Aspect 17, further comprising transmitting a negative acknowledgement message for at least a first transport block included in a PDSCH reception that overlaps with an SBFD symbol based at least in part on a valid symbol type being indicated as non-SBFD in the DCI.

Aspect 20: The method of any of Aspects 1-19, wherein the HARQ information is associated with the second HARQ type based at least in part on the UE not being provided with the HARQ bundling group information, based at least in part on the UE being provided with the spatial bundling information, and based at least in part on the UE being provided with the first SBFD configuration for a downlink bandwidth part of a plurality of downlink bandwidth parts from a network node configured for SBFD operations.

Aspect 21: The method of Aspect 20, further comprising generating a HARQ acknowledgement bit for each PDSCH reception of the multiple PDSCH receptions in ascending order of the PDSCH receptions based at least in part on performing a combination operation of one or more HARQ acknowledgement bits included in a first transport block and one or more HARQ acknowledgement bits included in a second transport block of each PDSCH reception of the multiple PDSCH receptions.

Aspect 22: The method of Aspect 20, further comprising transmitting a negative acknowledgement message for a PDSCH reception that overlaps with a non-SBFD symbol based at least in part on a valid symbol type being indicated as SBFD in the DCI.

Aspect 23: The method of Aspect 20, further comprising transmitting a negative acknowledgement message for a PDSCH reception that overlaps with an SBFD symbol based at least in part on a valid symbol type being indicated as non-SBFD in the DCI.

Aspect 24: A method of wireless communication performed by a network node, comprising: transmitting configuration information associated with a single downlink control information (DCI) communication scheduling multiple physical downlink shared channel (PDSCH) receptions, wherein the configuration information is associated with a first sub-band full-duplex (SBFD) configuration and a second SBFD configuration, the first SBFD configuration indicating that communications by a user equipment (UE) are restricted to only one of SBFD symbols or non-SBFD symbols across a plurality of slots and the second SBFD configuration indicating that communications by the UE can be performed in both the SBFD symbols and the non-SBFD symbols across the plurality of slots, wherein the configuration information further indicates for the UE to transmit hybrid automatic repeat request (HARQ) information associated with a first HARQ type or a second HARQ type based at least in part on whether the UE is provided with at least one of time domain bundling information or HARQ bundling group information and based at least in part on whether the UE is provided with spatial bundling information; transmitting DCI that schedules the multiple PDSCH receptions; and receiving HARQ information based at least in part on whether the UE is provided with the time domain bundling information or the HARQ bundling group information and based at least in part on whether the UE is provided with the spatial bundling information.

Aspect 25: The method of Aspect 24, wherein the first HARQ type is Type I HARQ codebook, the second HARQ type is Type II HARQ codebook, the time domain bundling information is a time domain HARQ bundling Type I indicator, the HARQ bundling group information is a number of HARQ bundling groups indicator, and the spatial bundling information is a HARQ acknowledgement spatial bundling physical uplink control channel indicator.

Aspect 26: The method of any of Aspects 24-25, wherein the HARQ information is associated with the first HARQ type based at least in part on the UE being provided with the time domain bundling information, based at least in part on the UE not being provided with the spatial bundling information, and based at least in part on the UE being provided with the first SBFD configuration for a downlink bandwidth part of a plurality of downlink bandwidth parts from a network node configured for SBFD operations.

Aspect 27: The method of Aspect 26, wherein a HARQ information bit included in a transport block is based at least in part on a combination operation of two or more HARQ acknowledgement information bits included in two or more PDSCH receptions of the multiple PDSCH receptions that do not overlap with an invalid symbol type.

Aspect 28: The method of Aspect 27, wherein a PDSCH reception included in a non-SBFD symbol is invalid based at least in part on a valid symbol type being indicated as SBFD in the DCI.

Aspect 29: The method of Aspect 27, wherein a PDSCH reception included in an SBFD symbol or in an uplink symbol is invalid based at least in part on a valid symbol type being indicated as non-SBFD in the DCI.

Aspect 30: The method of any of Aspects 24-29, wherein the HARQ information is associated with the first HARQ type based at least in part on the UE being provided with the time domain bundling information, based at least in part on the UE being provided with the spatial bundling information, and based at least in part on the UE being provided with the first SBFD configuration for a downlink bandwidth part of a plurality of downlink bandwidth parts from a network node configured for SBFD operations.

Aspect 31: The method of Aspect 30, wherein a HARQ information bit included in a transport block is based at least in part on a combination operation of two or more HARQ acknowledgement information bits included in two or more PDSCH receptions of the multiple PDSCH receptions that do not overlap with an invalid symbol type.

Aspect 32: The method of Aspect 31, wherein a PDSCH reception included in a non-SBFD symbol is invalid based at least in part on a valid symbol type being indicated as SBFD in the DCI.

Aspect 33: The method of Aspect 31, wherein a PDSCH reception included in an SBFD symbol or in an uplink symbol is invalid based at least in part on a valid symbol type being indicated as non-SBFD in the DCI.

Aspect 34: The method of any of Aspects 24-33, wherein the HARQ information is associated with the second HARQ type based at least in part on the UE being provided with the HARQ bundling group information, based at least in part on the UE not being provided with the spatial bundling information, and based at least in part on the UE being provided with the first SBFD configuration for a downlink bandwidth part of a plurality of downlink bandwidth parts from a network node configured for SBFD operations.

Aspect 35: The method of Aspect 34, wherein the configuration information indicates for the UE to process at least one of a transport block of a PDSCH reception overlapping with an uplink symbol, a transport block of an SBFD-specific PDSCH reception overlapping with an invalid non-SBFD symbol type, or a transport block of a non-SBFD-specific PDSCH reception overlapping with an invalid SBFD symbol type based at least in part on a transport block group associated with at least one PDSCH reception not overlapping with an uplink symbol and not overlapping with an invalid symbol type.

Aspect 36: The method of Aspect 34, further comprising receiving a negative acknowledgement message for a transport block group based at least in part on the transport block group being associated with a PDSCH reception that overlaps with an uplink symbol or being associated with a PDSCH reception that overlaps with an invalid symbol type.

Aspect 37: The method of any of Aspects 24-36, wherein the HARQ information is associated with the second HARQ type based at least in part on the UE being provided with the HARQ bundling group information, based at least in part on the UE being provided with the spatial bundling information, and based at least in part on the UE being provided with the first SBFD configuration for a downlink bandwidth part of a plurality of downlink bandwidth parts from a network node configured for SBFD operations.

Aspect 38: The method of Aspect 37, wherein the configuration information indicates for the UE to process at least one of a transport block of a PDSCH reception overlapping with an uplink symbol, a transport block of an SBFD-specific PDSCH reception overlapping with an invalid non-SBFD symbol type, or a transport block of a non-SBFD-specific PDSCH reception overlapping with an invalid SBFD symbol type based at least in part on a transport block group associated with at least one PDSCH reception not overlapping with an uplink symbol and not overlapping with an invalid symbol type.

Aspect 39: The method of Aspect 37, further comprising receiving a negative acknowledgement message for a transport block group based at least in part on the transport block group being associated with a PDSCH reception that overlaps with an uplink symbol or being associated with a PDSCH reception that overlaps with an invalid symbol type.

Aspect 40: The method of any of Aspects 24-39, wherein the HARQ information is associated with the second HARQ type based at least in part on the UE not being provided with the HARQ bundling group information, based at least in part on the UE not being provided with the spatial bundling information, and based at least in part on the UE being provided with the first SBFD configuration for a downlink bandwidth part of a plurality of downlink bandwidth parts from a network node configured for SBFD operations.

Aspect 41: The method of Aspect 40, further comprising receiving a negative acknowledgement message for at least a first transport block included in a PDSCH reception that overlaps with a non-SBFD symbol based at least in part on a valid symbol type being indicated as SBFD in the DCI.

Aspect 42: The method of Aspect 40, further comprising receiving a negative acknowledgement message for at least a first transport block included in a PDSCH reception that overlaps with an SBFD symbol based at least in part on a valid symbol type being indicated as non-SBFD in the DCI.

Aspect 43: The method of any of Aspects 24-42, wherein the HARQ information is associated with the second HARQ type based at least in part on the UE not being provided with the HARQ bundling group information, based at least in part on the UE being provided with the spatial bundling information, and based at least in part on the UE being provided with the first SBFD configuration for a downlink bandwidth part of a plurality of downlink bandwidth parts from a network node configured for SBFD operations.

Aspect 44: The method of Aspect 43, wherein the configuration information indicates for the UE to generate a HARQ acknowledgement bit for each PDSCH reception of the multiple PDSCH receptions in ascending order of the PDSCH receptions based at least in part on performing a combination operation of one or more HARQ acknowledgement bits included in a first transport block and one or more HARQ acknowledgement bits included in a second transport block of each PDSCH reception of the multiple PDSCH receptions.

Aspect 45: The method of Aspect 43, further comprising receiving a negative acknowledgement message for a PDSCH reception that overlaps with a non-SBFD symbol based at least in part on a valid symbol type being indicated as SBFD in the DCI.

Aspect 46: The method of Aspect 43, further comprising receiving a negative acknowledgement message for a PDSCH reception that overlaps with an SBFD symbol based at least in part on a valid symbol type being indicated as non-SBFD in the DCI.

Aspect 47: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-46.

Aspect 48: An apparatus for wireless communication at a device, the apparatus comprising one or more memories and one or more processors coupled to the one or more memories, the one or more processors configured to cause the device to perform the method of one or more of Aspects 1-46.

Aspect 49: An apparatus for wireless communication, the apparatus comprising at least one means for performing the method of one or more of Aspects 1-46.

Aspect 50: A non-transitory computer-readable medium storing code for wireless communication, the code comprising instructions executable by one or more processors to perform the method of one or more of Aspects 1-46.

Aspect 51: A non-transitory computer-readable medium storing a set of instructions for wireless communication, the set of instructions comprising one or more instructions that, when executed by one or more processors of a device, cause the device to perform the method of one or more of Aspects 1-46.

Aspect 52: A device for wireless communication, the device comprising a processing system that includes one or more processors and one or more memories coupled with the one or more processors, the processing system configured to cause the device to perform the method of one or more of Aspects 1-46.

Aspect 53: An apparatus for wireless communication at a device, the apparatus comprising one or more memories and one or more processors coupled to the one or more memories, the one or more processors individually or collectively configured to cause the device to perform the method of one or more of Aspects 1-46.

Aspect 54: A device comprising a processing system that includes one or more processors and one or more code-storing memories coupled with the one or more processors, the processing system configured to cause the device to perform the method of one or more of Aspects 1-46.

Aspect 55: A device comprising a processing system that includes processor circuitry and code-storing memory circuitry, the processing system configured to cause the device to perform the method of one or more of Aspects 1-46.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, which, individually or in any combination, are operable to cause the UE to:
receive configuration information associated with a single downlink control information (DCI) communication scheduling multiple physical downlink shared channel (PDSCH) receptions, wherein the configuration information is associated with a first sub-band full-duplex (SBFD) configuration and a second SBFD configuration, the first SBFD configuration indicating that communications by the UE are restricted to only one of SBFD symbols or non-SBFD symbols across a plurality of slots and the second SBFD configuration indicating that communications by the UE can be performed in both the SBFD symbols and the non-SBFD symbols across the plurality of slots, wherein the configuration information further indicates for the UE to transmit hybrid automatic repeat request (HARQ) information associated with a first HARQ type or a second HARQ type based at least in part on whether the UE is provided with at least one of time domain bundling information or HARQ bundling group information and based at least in part on whether the UE is provided with spatial bundling information;
receive DCI that schedules the multiple PDSCH receptions; and
transmit HARQ information based at least in part on whether the UE is provided with the time domain bundling information or the HARQ bundling group information and based at least in part on whether the UE is provided with the spatial bundling information.

2. The apparatus of claim 1, wherein the first HARQ type is Type I HARQ codebook, the second HARQ type is Type II HARQ codebook, the time domain bundling information is a time domain HARQ bundling Type I indicator, the HARQ bundling group information is a number of HARQ bundling groups indicator, and the spatial bundling information is a HARQ acknowledgement spatial bundling physical uplink control channel indicator.

3. The apparatus of claim 1, wherein the HARQ information is associated with the first HARQ type based at least in part on the UE being provided with the time domain bundling information, based at least in part on the UE not being provided with the spatial bundling information, and based at least in part on the UE being provided with the first SBFD configuration for a downlink bandwidth part of a plurality of downlink bandwidth parts from a network node configured for SBFD operations.

4. The apparatus of claim 3, wherein a HARQ information bit included in a transport block is based at least in part on a combination operation of two or more HARQ acknowledgement information bits included in two or more PDSCH receptions of the multiple PDSCH receptions that do not overlap with an invalid symbol type.

5. The apparatus of claim 4, wherein a PDSCH reception included in a non-SBFD symbol is invalid based at least in part on a valid symbol type being indicated as SBFD in the single DCI communication, or is included in an SBFD symbol or in an uplink symbol is invalid based at least in part on a valid symbol type being indicated as non-SBFD in the single DCI communication.

6. The apparatus of claim 1, wherein the HARQ information is associated with the first HARQ type based at least in part on the UE being provided with the time domain bundling information, based at least in part on the UE being provided with the spatial bundling information, and based at least in part on the UE being provided with the first SBFD configuration for a downlink bandwidth part of a plurality of downlink bandwidth parts from a network node configured for SBFD operations.

7. The apparatus of claim 6, wherein a HARQ information bit included in a transport block is based at least in part on a combination operation of two or more HARQ acknowledgement information bits included in two or more PDSCH receptions of the multiple PDSCH receptions that do not overlap with an invalid symbol type.

8. The apparatus of claim 7, wherein a PDSCH reception included in a non-SBFD symbol is invalid based at least in part on a valid symbol type being indicated as SBFD in the single DCI communication, or is included in an SBFD symbol or in an uplink symbol is invalid based at least in part on a valid symbol type being indicated as non-SBFD in the single DCI communication.

9. The apparatus of claim 1, wherein the HARQ information is associated with the second HARQ type based at least in part on the UE being provided with the HARQ bundling group information, based at least in part on the UE not being provided with the spatial bundling information, and based at least in part on the UE being provided with the first SBFD configuration for a downlink bandwidth part of a plurality of downlink bandwidth parts from a network node configured for SBFD operations.

10. The apparatus of claim 9, wherein the one or more processors are further configured to cause the UE to process at least one of a transport block of a PDSCH reception overlapping with an uplink symbol, a transport block of an SBFD-specific PDSCH reception overlapping with an invalid non-SBFD symbol type, or a transport block of a non-SBFD-specific PDSCH reception overlapping with an invalid SBFD symbol type based at least in part on a transport block group associated with at least one PDSCH reception not overlapping with an uplink symbol and not overlapping with an invalid symbol type.

11. The apparatus of claim 9, wherein the one or more processors are further configured to cause the UE to transmit a negative acknowledgement message for a transport block group based at least in part on the transport block group being associated with a PDSCH reception that overlaps with an uplink symbol or being associated with a PDSCH reception that overlaps with an invalid symbol type.

12. The apparatus of claim 1, wherein the HARQ information is associated with the second HARQ type based at least in part on the UE being provided with the HARQ bundling group information, based at least in part on the UE being provided with the spatial bundling information, and based at least in part on the UE being provided with the first SBFD configuration for a downlink bandwidth part of a plurality of downlink bandwidth parts from a network node configured for SBFD operations.

13. The apparatus of claim 12, wherein the one or more processors are further configured to cause the UE to process at least one of a transport block of a PDSCH reception overlapping with an uplink symbol, a transport block of an SBFD-specific PDSCH reception overlapping with an invalid non-SBFD symbol type, or a transport block of a non-SBFD-specific PDSCH reception overlapping with an invalid SBFD symbol type based at least in part on a transport block group associated with at least one PDSCH reception not overlapping with an uplink symbol and not overlapping with an invalid symbol type.

14. The apparatus of claim 12, wherein the one or more processors are further configured to cause the UE to transmit a negative acknowledgement message for a transport block group based at least in part on the transport block group being associated with a PDSCH reception that overlaps with an uplink symbol or being associated with a PDSCH reception that overlaps with an invalid symbol type.

15. The apparatus of claim 1, wherein the HARQ information is associated with the second HARQ type based at least in part on the UE not being provided with the HARQ bundling group information, based at least in part on the UE not being provided with the spatial bundling information, and based at least in part on the UE being provided with the first SBFD configuration for a downlink bandwidth part of a plurality of downlink bandwidth parts from a network node configured for SBFD operations.

16. The apparatus of claim 15, wherein the one or more processors are further configured to cause the UE to transmit a negative acknowledgement message for at least a first transport block included in a PDSCH reception that overlaps with a non-SBFD symbol based at least in part on a valid symbol type being indicated as SBFD in the single DCI communication, or to transmit a negative acknowledgement message for at least a first transport block included in a PDSCH reception that overlaps with an SBFD symbol based at least in part on a valid symbol type being indicated as non-SBFD in the single DCI communication.

17. The apparatus of claim 1, wherein the HARQ information is associated with the second HARQ type based at least in part on the UE not being provided with the HARQ bundling group information, based at least in part on the UE being provided with the spatial bundling information, and based at least in part on the UE being provided with the first SBFD configuration for a downlink bandwidth part of a plurality of downlink bandwidth parts from a network node configured for SBFD operations.

18. The apparatus of claim 17, wherein the one or more processors are further configured to cause the UE to generate a HARQ acknowledgement bit for each PDSCH reception of the multiple PDSCH receptions in ascending order of the PDSCH receptions based at least in part on performing a combination operation of one or more HARQ acknowledgement bits included in a first transport block and one or more HARQ acknowledgement bits included in a second transport block of each PDSCH reception of the multiple PDSCH receptions.

19. An apparatus for wireless communication at a network node, comprising:
one or more memories; and
one or more processors, coupled to the one or more memories, which, individually or in any combination, are operable to cause the network node to:
transmit configuration information associated with a single downlink control information (DCI) communication scheduling multiple physical downlink shared channel (PDSCH) receptions, wherein the configuration information is associated with a first sub-band full-duplex (SBFD) configuration and a second SBFD configuration, the first SBFD configuration indicating that communications by a user equipment (UE) are restricted to only one of SBFD symbols or non-SBFD symbols across a plurality of slots and the second SBFD configuration indicating that communications by the UE can be performed in both the SBFD symbols and the non-SBFD symbols across the plurality of slots, wherein the configuration information further indicates for the UE to transmit hybrid automatic repeat request (HARQ) information associated with a first HARQ type or a second HARQ type based at least in part on whether the UE is provided with at least one of time domain bundling information or HARQ bundling group information and based at least in part on whether the UE is provided with spatial bundling information;
transmit DCI that schedules the multiple PDSCH receptions; and
receive HARQ information based at least in part on whether the UE is provided with the time domain bundling information or the HARQ bundling group information and based at least in part on whether the UE is provided with the spatial bundling information.

20. A method of wireless communication performed by a user equipment (UE), comprising:
receiving configuration information associated with a single downlink control information (DCI) communication scheduling multiple physical downlink shared channel (PDSCH) receptions, wherein the configuration information is associated with a first sub-band full-duplex (SBFD) configuration and a second SBFD configuration, the first SBFD configuration indicating that communications by the UE are restricted to only one of SBFD symbols or non-SBFD symbols across a plurality of slots and the second SBFD configuration indicating that communications by the UE can be performed in both the SBFD symbols and the non-SBFD symbols across the plurality of slots, wherein the configuration information further indicates for the UE to transmit hybrid automatic repeat request (HARQ) information associated with a first HARQ type or a second HARQ type based at least in part on whether the UE is provided with at least one of time domain bundling information or HARQ bundling group information and based at least in part on whether the UE is provided with spatial bundling information;
receiving DCI that schedules the multiple PDSCH receptions; and
transmitting HARQ information based at least in part on whether the UE is provided with the time domain bundling information or the HARQ bundling group information and based at least in part on whether the UE is provided with the spatial bundling information.
